(19) United States
(12) Patent Application Publication
(10) Pub. No.: US 2026/0256183 A1
(43) Pub. Date: Sep. 3, 2026

(54) A CONSUMABLE

(71) Applicant: Nicoventures Trading Limited, London (GB)

(72) Inventors: John RICHARDSON, London (GB); Walid ABI AOUN, London (GB)

(21) Appl. No.: 19/162,107

(22) PCT Filed: Jan. 31, 2024
(86) PCT No.: PCT/GB2024/050265

§ 371 Date: Sep. 4, 2025

(30) Foreign Application Priority Data
Mar. 13, 2023 (GB) 2303668.4

(51) Int. Cl. A24B 15/16; A24B 3/14; A24B 15/14; A24B 15/30; A24B 15/32; A24B 15/38; A24F 40/20; H05B 6/10

(52) U.S. Cl. CPC A24B 15/16; A24B 3/14; A24B 15/14; A24B 15/302; A24B 15/32; A24B 15/385; A24F 40/20; H05B 6/105

(57) ABSTRACT

An aerosol-generating material comprising a plurality of strands and/or strips of an aerosol generating non-tobacco material and a plurality of strips of an other non-tobacco material. Also disclosed is an article comprising such an aerosol-generating material, a consumable comprising such an article, and a non-combustible aerosol provision system comprising a non-combustible aerosol provision device and such a consumable, wherein the device is arranged to heat the aerosol generating material composition of the consumable. Also disclosed are methods for producing such an aerosol-generating material composition.

### CROSS-REFERENCE TO RELATED APPLICATIONS

This present application is a National Phase entry of PCT Application No. PCT/GB 2024/050265, filed 31 Jan. 2024, which claims priority from Great Britain Application No. 2303668.4, filed 13 Mar. 2023, each of which are fully incorporated herein by reference in their entireties.

### TECHNICAL FIELD

The present invention relates to a consumable for use in an aerosol provision system, a non-combustible aerosol provision system, and a method for producing a consumable.

### BACKGROUND

Certain tobacco industry products produce an aerosol during use, which is inhaled by a user. For example, tobacco heating devices heat an aerosol generating substrate such as tobacco to form an aerosol by heating, but not burning, the substrate. Such tobacco industry products can include mouthpieces through which the aerosol passes to reach the user's mouth.

### SUMMARY

In accordance with some embodiments described herein, in a first aspect there is provided an aerosol-generating material comprising a plurality of strands and/or strips of an aerosol generating non-tobacco material and a plurality of strips of an other non-tobacco material.

In accordance with some embodiments described herein, in a second aspect there is provided an article comprising the aerosol generating material of the first aspect.

In accordance with some embodiments described herein, in a third aspect there is provided a consumable for use in an aerosol provision system, wherein the consumable comprises the article of the second aspect.

In accordance with some embodiments described herein, in a fourth aspect there is provided a non-combustible aerosol provision system comprising a non-combustible aerosol provision device and a consumable according to the third aspect, wherein the device is arranged to heat the aerosol generating material composition of the consumable.

In accordance with some embodiments described herein, in a fifth aspect there is provided a method for producing an aerosol-generating material composition according to the first aspect, comprising cutting a sheet of aerosol generating non-tobacco material to form a plurality of strips of aerosol generating non-tobacco material.

### BRIEF DESCRIPTION OF THE DRAWINGS

Embodiments of the invention will now be described, by way of example only, with reference to accompanying drawings, in which:

FIG. 1 is a side-on cross sectional view of an article for use with a non-combustible aerosol provision device, the article including a mouthpiece;

FIG. 2a is a side-on cross sectional view of a further article for use with a non-combustible aerosol provision device, in this example the article including a capsule-containing mouthpiece;

FIG. 2b is a cross sectional view of the capsule-containing mouthpiece shown in FIG. 2a;

FIG. 3 is a flow diagram illustrating a first method of manufacturing an aerosol-generating material;

FIG. 4 is a flow diagram illustrating a second method of manufacturing an aerosol-generating material; and

FIG. 5 is a schematic illustration of a system comprising a device and consumable.

### DETAILED DESCRIPTION

As used herein, the term “delivery system” is intended to encompass systems that deliver at least one substance to a user, and includes:
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavours, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B₁₂ or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B₁₂.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c. v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavour.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “aerosol generating non-tobacco”, which may alternatively be referred to as a “monolithic solid” (i.e. non-fibrous). In some embodiments, the aerosol generating non-tobacco may be a dried gel. The aerosol generating non-tobacco is a solid material that may retain some fluid, such as liquid, within it.

The aerosol-generating non-tobacco material may comprise a binder; an aerosol-former material; filler; and/or one or more flavourant and/or active.

In one embodiment, the aerosol-generating non-tobacco material comprises an aerosol-former material; a binder; optionally a filler; and optionally one or more flavourants and/or actives.

In one embodiment, the aerosol-generating non-tobacco material comprises a binder; an aerosol-former material; filler; and one or more flavourant and/or active.

In one embodiment, the aerosol generating non-tobacco material may be an aerosol generating film, wherein the aerosol generating film is up to about 1 mm thick and, optionally, up to 500 microns thick and, optionally, 50 to 500 microns thick.

In some examples, the aerosol generating non-tobacco comprises:
1-60 wt % of a gelling agent;
0.1-50 wt % of an aerosol-former agent; and
0.1-80 wt % of a flavour; wherein these weights are calculated on a dry weight basis.

In some further embodiments, the aerosol generating non-tobacco comprises:
1-50 wt % of a gelling agent;
0.1-50 wt % of an aerosol-former agent; and
30-60 wt % of a flavour;
   wherein these weights are calculated on a dry weight basis.

The aerosol generating non-tobacco material may be provided in sheet form.

In some further embodiments, the aerosol generating non-tobacco comprises:
aerosol-former material in an amount of from about 40 to 80 wt % of the aerosol generating non-tobacco;
gelling agent and optional filler (i.e. in some examples filler is present in the aerosol generating non-tobacco, in other examples filler is not present in the aerosol generating non-tobacco), wherein the amount of gelling agent and filler taken together is from about 10 to 60 wt % of the aerosol generating non-tobacco (i.e. the gelling agent and filler taken together account for about 10 to 60 wt % of the aerosol generating non-tobacco); and
optionally, active substance and/or flavourant in an amount of up to about 20 wt % of the aerosol generating non-tobacco (i.e. the aerosol generating non-tobacco comprises ≤20 wt % active substance).

The aerosol generating non-tobacco material can be formed from a dried gel. The inventors have found that using these component proportions means as the gel sets, flavour compounds are stabilised within the gel matrix allowing a higher flavour loading to be achieved than in non-gel compositions. The flavouring (e.g. menthol) is stabilised at high concentrations and the products have a good shelf life.

Suitably, the aerosol generating non-tobacco may comprise from about 1 wt %, 5 wt %, 10 wt %, 15 wt %, 20 wt %, 25 wt %, 30 wt % or 35 wt % to about 60 wt %, 55 wt %, 50 wt %, 45 wt %, 40 wt % or 35 wt % of a gelling agent (all calculated on a dry weight basis). For example, the aerosol generating non-tobacco may comprise 1-60 wt %, 5-60 wt %, 20-60 wt %, 25-55 wt %, 30-50 wt %, 35-45 wt %, 1-50 wt %, 5-45 wt %, 10-40 wt % or 20-35 wt % of a gelling agent. In some embodiments, the gelling agent comprises a hydrocolloid. In some embodiments, the gelling agent comprises one or more compounds selected from the group comprising alginates, pectins, starches (and derivatives), celluloses (and derivatives), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum guar gum, carrageenan, agarose, acacia gum, fumed silica, PDMS, sodium silicate, kaolin and polyvinyl alcohol. In some cases, the gelling agent comprises alginate and/or pectin, and may be combined with a setting agent (such as a calcium source) during formation of the aerosol generating non-tobacco. In some cases, the aerosol generating non-tobacco may comprise a calcium-crosslinked alginate and/or a calcium-crosslinked pectin.

In some embodiments, the gelling agent comprises alginate, and the alginate is present in the aerosol generating non-tobacco in an amount of from 5-40 wt %, for example 10-30 wt % of the aerosol generating non-tobacco (calculated on a dry weight basis). In some embodiments, alginate is the only gelling agent present in the aerosol generating non-tobacco. In other embodiments, the gelling agent comprises alginate and at least one further gelling agent, such as pectin.

In some examples, alginate is comprised in the gelling agent in an amount of from about 5 to 40 wt % of the aerosol generating non-tobacco, or 15 to 40 wt %. That is, the aerosol generating non-tobacco comprises alginate in an amount of about 5 to 40 wt % by dry weight of the aerosol generating non-tobacco, or 15 to 40 wt %. In some examples, the aerosol generating non-tobacco comprises alginate in an amount of from about 20 to 40 wt %, or about 15 wt % to 35 wt % of the aerosol generating non-tobacco.

In some examples, pectin is comprised in the gelling agent in an amount of from about 3 to 15 wt % of the aerosol generating non-tobacco. That is, the aerosol generating non-tobacco comprises pectin in an amount of from about 3 to 15 wt % by dry weight of the aerosol generating non-tobacco. In some examples, the aerosol generating non-tobacco comprises pectin in an amount of from about 5 to 10 wt % of the aerosol generating non-tobacco.

In some examples, guar gum is comprised in the gelling agent in an amount of from about 3 to 40 wt % of the aerosol generating non-tobacco. That is, the aerosol generating non-tobacco comprises guar gum in an amount of from about 3 to 40 wt % by dry weight of the aerosol generating non-tobacco. In some examples, the aerosol generating non-tobacco comprises guar gum in an amount of from about 5 to 10 wt % of the aerosol generating non-tobacco. In some examples, the aerosol generating non-tobacco comprises guar gum in an amount of from about 15 to 40 wt % of the aerosol generating non-tobacco, or from about 20 to 40 wt %, or from about 15 to 35 wt %.

In some examples, the alginate is present in an amount of at least about 50 wt % of the gelling agent. In examples, the aerosol generating non-tobacco comprises alginate and pectin, and the ratio of the alginate to the pectin is from 1:1 to 10:1. The ratio of the alginate to the pectin is typically >1:1, i.e. the alginate is present in an amount greater than the amount of pectin. In examples, the ratio of alginate to pectin is from about 2:1 to 8:1, or about 3:1 to 6:1, or is approximately 4:1.

In some embodiments the aerosol generating non-tobacco may include gelling agent comprising carrageenan.

The gelling agent may comprise one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

Suitably, the aerosol generating non-tobacco may comprise from about 0.1 wt %, 0.5 wt %, 1 wt %, 3 wt %, 5 wt %, 7 wt % or 10% to about 80 wt %, 50 wt %, 45 wt %, 40 wt %, 35 wt %, 30 wt % or 25 wt % of an aerosol-former material (all calculated on a dry weight basis). For example, the aerosol generating non-tobacco may comprise about 40-80 wt %, 40-75 wt %, 50-70 wt %, or 55-65 wt % aerosol-former material. The aerosol-former material may act as a plasticiser. For example, the aerosol generating non-tobacco may comprise 0.5-40 wt %, 3-35 wt % or 10-25 wt % of an aerosol-former material. In some cases, the aerosol-former material comprises one or more compound selected from erythritol, propylene glycol, glycerol, triacetin, sorbitol and xylitol. In some cases, the aerosol-former material comprises, consists essentially of or consists of glycerol.

In some embodiments, the aerosol-former comprises one or more polyhydric alcohols, such as propylene glycol, triethylene glycol, 1,3-butanediol and glycerin; esters of polyhydric alcohols, such as glycerol mono-, di-or triacetate; and/or aliphatic esters of mono-, di-or polycarboxylic acids, such as dimethyl dodecanedioate and dimethyl tetradecanedioate.

The aerosol generating non-tobacco may comprise a flavour. Suitably, the aerosol generating non-tobacco may comprise up to about 80 wt %, 70 wt %, 60 wt %, 55 wt %, 50 wt % or 45 wt % of a flavour.

In some cases, the aerosol generating non-tobacco may comprise at least about 0.1 wt %, 1 wt %, 10 wt %, 20 wt %, 30 wt %, 35 wt % or 40 wt % of a flavour (all calculated on a dry weight basis).

For example, the aerosol generating non-tobacco may comprise 1-80 wt %, 10-80 wt %, 20-70 wt %, 30-60 wt %, 35-55 wt % or 30-45 wt % of a flavour. In some cases, the flavour comprises, consists essentially of or consists of menthol.

In some cases, the aerosol generating non-tobacco may additionally comprise an emulsifying agent, which emulsified molten flavour during manufacture. For example, the aerosol generating non-tobacco may comprise from about 5 wt % to about 15 wt % of an emulsifying agent (calculated on a dry weight basis), suitably about 10 wt %. The emulsifying agent may comprise acacia gum.

In some embodiments, the aerosol generating non-tobacco is a hydrogel and comprises less than about 20 wt % of water calculated on a wet weight basis. In some cases, the hydrogel may comprise less than about 15 wt %, 12 wt % or 10 wt % of water calculated on a wet weight basis. In some cases, the hydrogel may comprise at least about 1 wt %, 2 wt % or at least about 5 wt % of water (WWB).

In some embodiments, the aerosol generating non-tobacco additionally comprises an active substance. For example, in some cases, the aerosol generating non-tobacco material additionally comprises nicotine. In some cases, the aerosol generating non-tobacco may comprise 5-60 wt % (calculated on a dry weight basis) of nicotine. In some cases, the aerosol generating non-tobacco may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, 30 wt %, 20 wt %, 15 wt %, or 10 wt % (calculated on a dry weight basis) of an active substance. In some cases, the aerosol generating non-tobacco may comprise from about 1 wt %, 2 wt %, 3 wt % or 4 wt % to about 20 wt %, 18 wt %, 15 wt % or 12 wt % (calculated on a dry weight basis) of nicotine. For example, the aerosol generating non-tobacco may comprise 1-20 wt %, 2-18 wt % or 3-12 wt % of nicotine.

In some cases, the aerosol generating non-tobacco comprises an active substance such as tobacco extract. In some cases, the aerosol generating non-tobacco may comprise 5-60 wt % (calculated on a dry weight basis) of tobacco extract. In some cases, the aerosol generating non-tobacco may comprise from about 5 wt %, 10 wt %, 15 wt %, 20 wt % or 25 wt % to about 60 wt %, 50 wt %, 45 wt %, 40 wt %, 35 wt %, or 30 wt % (calculated on a dry weight basis) tobacco extract. For example, the aerosol generating non-tobacco may comprise 10-50 wt %, 15-40 wt % or 20-35 wt % of tobacco extract. The tobacco extract may contain nicotine at a concentration such that the aerosol generating non-tobacco comprises 1 wt % 1.5 wt %, 2 wt % or 2.5 wt % to about 6 wt %, 5 wt %, 4.5 wt % or 4 wt % (calculated on a dry weight basis) of nicotine.

It will be appreciated that ‘tobacco extract’ includes extracts of tobacco, such as nicotine or flavours of tobacco; but does not comprise tobacco itself. In this respect, the aerosol generating non-tobacco does not include tobacco but may comprise a tobacco extract. By ‘tobacco itself’, it is meant tobacco plant material such as ground tobacco, cut tobacco, tobacco fibre, tobacco stem, tobacco lamina or any form of reconstituted tobacco material.

In some cases, there may be no nicotine in the aerosol generating non-tobacco other than that which results from the tobacco extract.

In some embodiments the aerosol generating non-tobacco material comprises nicotine. In some such cases, the aerosol generating non-tobacco may comprise from about 1 wt %, 2 wt %, 3 wt % or 4 wt % to about 20 wt %, 18 wt %, 15 wt % or 12 wt % (calculated on a dry weight basis) of nicotine. For example, the aerosol generating non-tobacco may comprise 1-20 wt %, 2-18 wt % or 3-12 wt % of nicotine.

In some cases, the total content of active substance and/or flavour may be at least about 0.1 wt %, 1 wt %, 5 wt %, 10 wt %, 20 wt %, 25 wt % or 30 wt %. In some cases, the total content of active substance and/or flavour may be less than about 90 wt %, 80 wt %, 70 wt %, 60 wt %, 50 wt % or 40 wt % (all calculated on a dry weight basis).

In some cases, the total content of nicotine and flavour may be at least about 0.1 wt %, 1 wt %, 5 wt %, 10 wt %, 20 wt %, 25 wt % or 30 wt %. In some cases, the total content of active substance and/or flavour may be less than about 90 wt %, 80 wt %, 70 wt %, 60 wt %, 50 wt % or 40 wt % (all calculated on a dry weight basis).

The aerosol generating non-tobacco may be made from a gel, and this gel may additionally comprise a solvent, included at 0.1-50 wt %. However, the inventors have established that the inclusion of a solvent in which the flavour is soluble may reduce the gel stability and the flavour may crystallise out of the gel. As such, in some cases, the gel does not include a solvent in which the flavour is soluble.

The aerosol generating non-tobacco may comprise filler. Taken together, the aerosol generating non-tobacco typically comprises gelling agent and filler (if present) in an amount of from about 10 to 60 wt % of the aerosol generating non-tobacco. In examples, the aerosol generating non-tobacco comprises filler in an amount of from 1 to 15 wt % of the aerosol generating non-tobacco, such as 5 wt % to 15 wt %, or 8 to 12 wt %. In examples, the aerosol generating non-tobacco comprises filler in an amount greater than 1 wt %, 5 wt %, or 8 wt % of the aerosol generating non-tobacco. In some embodiments, the aerosol generating non-tobacco comprises less than 60 wt % of a filler, such as from 1 wt % to 60 wt %, or 5 wt % to 50 wt %, or 5 wt % to 30 wt %, or 10 wt % to 20 wt %.

In other embodiments, the aerosol generating non-tobacco comprises less than 40 wt % 20 wt %, suitably less than 10 wt % or less than 5 wt % of a filler. In some cases, the aerosol generating non-tobacco comprises less than 1 wt % of a filler, and in some cases, comprises no filler.

The filler, if present, may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives. In particular cases, the aerosol generating non-tobacco comprises no calcium carbonate such as chalk.

In particular embodiments which include filler, the filler is fibrous. For example, the filler may be a fibrous organic filler material such as wood pulp, hemp fibre, cellulose or cellulose derivatives. Without wishing to be bound by theory, it is believed that including fibrous filler in an aerosol generating non-tobacco may increase the tensile strength of the material.

In some embodiments, the aerosol generating non-tobacco comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosol generating non-tobacco may comprise one or more cannabinoid compounds selected from the group consisting of cannabidiol (CBD) and THC (tetrahydrocannabinol).

The aerosol generating non-tobacco may comprise cannabidiol (CBD).

The aerosol generating non-tobacco may comprise nicotine and cannabidiol (CBD).

The aerosol generating non-tobacco may comprise nicotine, cannabidiol (CBD), and THC (tetrahydrocannabinol).

In some embodiments, the aerosol generating non-tobacco does not comprise tobacco fibres.

In some examples, the aerosol generating non-tobacco in sheet form may have a tensile strength of from around 150 N/m to around 3000 N/m, for instance from 150 N/m to 2500 N/m, or 150 N/m to 2000 N/m, or 200 N/m to 1700 N/m, or 250 N/m to 1500 N/m, or 200 N/m to 900 N/m. In some examples, such as where the aerosol generating non-tobacco does not comprise a filler, the aerosol generating non-tobacco may have a tensile strength of from 150 N/m to 500 N/m, or 200 N/m to 400 N/m, or 200 N/m to 300 N/m, or about 250 N/m. Such tensile strengths may be particularly suitable for embodiments wherein the aerosol generating non-tobacco material is formed as a sheet and then shredded and incorporated into an aerosol-generating article.

In some examples, such as where the aerosol generating non-tobacco comprises a filler, the aerosol generating non-tobacco may have a tensile strength of from 150 N/m to 3000 N/m, for example 500 N/m to 1200 N/m, or from 600 N/m to 900 N/m, or from 700 N/m to 900 N/m, or around 800 N/m or greater. In some examples, the aerosol generating non-tobacco may have a tensile strength of greater than 500 N/m, greater than 1000 N/m or greater than 1500 N/m. Such tensile strengths may be particularly suitable for embodiments wherein the aerosol generating non-tobacco material is included in an aerosol-generating article as a rolled sheet, suitably in the form of a tube. In certain embodiments, the aerosol generating non-tobacco comprises a gelling agent comprising a cellulosic gelling agent and/or a non-cellulosic gelling agent, an active substance and an acid.

In some cases, the aerosol generating non-tobacco may consist essentially of, or consist of a gelling agent, water, an aerosol-former material, a flavour, and optionally an active substance.

In some cases, the aerosol generating non-tobacco may consist essentially of, or consist of a gelling agent, water, an aerosol-former material, a flavour, and optionally nicotine or a nicotine source.

The aerosol generating non-tobacco may comprise one or more active substances and/or flavours, one or more aerosol-former materials, and optionally one or more other functional material.

A further aspect of the invention provides a method of making the consumable of the invention. This method comprises a method of making the aerosol-generating non-tobacco material and incorporating the aerosol-generating non-tobacco material into the consumable.

The method may comprise (a) providing a slurry comprising components of the aerosol-generating non-tobacco material or precursors thereof, (b) forming a layer of the slurry, and (c) drying the slurry to form the aerosol-generating non-tobacco material, and (d) incorporating the aerosol-generating non-tobacco material into the consumable. The consumable comprises the amount of aerosol-generating non-tobacco material as described herein, and does not comprise tobacco.

The slurry may comprise a solvent and one or more of a binder, an aerosol-formed material, a filler, and one or more flavourants and/or actives.

Thus, the steps of forming the aerosol-generating non-tobacco material may comprise:
(a) providing a slurry comprising:
(i) optionally a binder;
(ii) an aerosol-former material;
(iii) optionally filler;
(iv) optionally one or more flavourants and/or actives; and
(v) solvent;
   (b) forming a layer of the slurry; and
   (c) drying the slurry.

Drying the slurry forms an aerosol-generating material.

In one aspect, the steps of forming the aerosol-generating material comprise:
(a) providing a slurry comprising:
(i) a binder;
(ii) an aerosol-former material;
(iii) filler;
(iv) one or more flavourants and/or actives; and
(v) solvent;
   (b) forming a layer of the slurry; and
   (c) drying the slurry.

In another aspect, any flavourants are added to the slurry after it is formed and dried. In this case after step (c) the method comprises adding one or more flavourants to the aerosol-generating non-tobacco material, for example by spraying the flavourant(s) (or a composition comprising the flavourant(s)) onto the aerosol-generating non-tobacco material.

Thus, the steps of forming the aerosol-generating non-tobacco material may comprise:
(a) providing a slurry comprising:
(i) a binder;
(ii) an aerosol-former material;
(iii) filler;
(iv) optionally one or more actives; and
(v) solvent;
   (b) forming a layer of the slurry;
   (c) drying the slurry thereby forming an aerosol-generating non-tobacco material; and
   (d) adding one or more flavourants to the aerosol-generating non-tobacco material, for example by spraying the flavourant(s) (or a composition comprising the flavourant(s)) onto the aerosol-generating non-tobacco material.

The aerosol-generating non-tobacco material formed as described above may then be incorporated or formed into a consumable in any of the amounts described herein.

Step (b) of forming a layer of the slurry may comprise spraying, casting or extruding the slurry. In some cases, the layer of slurry is formed by casting the slurry.

In some cases, a setting agent (such as a calcium source) may be added to the slurry before or during step (b). This is appropriate in instances where gelation occurs relatively slowly, and thus the slurry may be, e.g. cast, after the setting agent is added.

In other cases, step I of drying the slurry as a gel may comprise the addition of a setting agent to the slurry layer. The setting agent may be sprayed onto the gel, for example, or may be preloaded onto the surface on which the slurry is layered.

For example, a setting agent comprising a calcium source may be added to a slurry containing alginate and/or pectin to form a calcium-crosslinked alginate/pectin gel. In some cases where gelation occurs rapidly (such as those in which a alginate or pectin gelling agent is used), the calcium should be added after casting (because the gel is too viscous to cast).

In examples, the setting agent comprises or consists of calcium acetate, calcium formate, calcium carbonate, calcium hydrogencarbonate, calcium chloride, calcium lactate, or a combination thereof. In some examples, the setting agent comprises or consists of calcium formate and/or calcium lactate. In particular examples, the setting agent comprises or consists of calcium formate.

The total amount of the setting agent, such as a calcium source, may be from about 0.5 to about 5 wt % (calculated on a dry weight basis). Suitably, the total amount may be from about 1 wt %, 2.5 wt % or 4 wt % to about 4.8 wt % or 4.5 wt %. The addition of too little setting agent may result in a gel which does not stabilise the flavourant and results in the flavourant dropping out of the gel. Conversely, the addition of too much setting agent may result in a gel that is very viscous and difficult to cast.
When present, step (d) comprises the addition of one or more flavourants to the slurry layer. The flavourant(s) may be sprayed onto the slurry. The flavourant(s) may be applied neat, i.e. in pure form, or may be applied as part of a composition. For example, the one or more flavourants may be dissolved in a solvent (e.g. ethanol), before the solution is applied to the dried slurry or aerosol-generating non-tobacco material. The solvent (e.g. ethanol) may then be removed by evaporation, such as flash evaporation. Where multiple flavourants are present these may be added simultaneously (optionally as part of a composition also comprising a solvent such as ethanol), or may be applied sequentially (optionally each as part of a composition also comprising a solvent such as ethanol).
Alginate salts are derivatives of alginic acid and are typically high molecular weight polymers (10-600 kDa). Alginic acid is a copolymer of β-D-mannuronic (M) and α-L-guluronic acid (G) units (blocks) linked together with (1,4)-glycosidic bonds to form a polysaccharide. On addition of calcium cations, the alginate crosslinks to form a gel. Alginate salts with a high G monomer content more readily form a gel on addition of the calcium source. In some cases therefore, the gel-precursor pay comprise an alginate salt in which at least about 40%, 45%, 50%, 55%, 60% or 70% of the monomer units in the alginate copolymer are α-L-guluronic acid (G) units.

In some cases, the slurry may be warmed prior to and during casting. This can slow gelation, improving handleability and easing the casting process. Further, warming the slurry may melt the flavourant components (e.g. menthol) easing handleability.

In some cases, the slurry may be cast as a bandcast sheet. The sheet may be loaded with a releasing agent, such as lecithin, which can aid separation of the bandcast and the amorphous solid. In other instances, the band may be covered with a film of releasing agent, such as lecithin, to aid the separation.

In cases where the solvent consists of water, the dry weight content of the slurry will match the dry weight content of the amorphous solid. Thus, the discussion herein relating to the solid material is explicitly disclosed in combination with any slurry aspect of the invention.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The aerosol generating non-tobacco may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

The inclusion of an acid is particularly preferred in embodiments in which aerosol generating non-tobacco comprises nicotine. In such embodiments, the presence of an acid may stabilise dissolved species in the slurry from which the aerosol-generating material is formed. The presence of the acid may reduce or substantially prevent evaporation of nicotine during drying of the slurry, thereby reducing loss of nicotine during manufacturing.

The aerosol generating non-tobacco may comprise a colourant. The addition of a colourant may alter the visual appearance of the aerosol generating non-tobacco. The presence of colourant in the aerosol generating non-tobacco may enhance the visual appearance of the aerosol generating non-tobacco and the aerosol-generating material. By adding a colourant to the aerosol generating non-tobacco, the aerosol generating non-tobacco may be colour-matched to other components of the aerosol-generating material or to other components of an article comprising the aerosol generating non-tobacco.

A variety of colourants may be used depending on the desired colour of the aerosol generating non-tobacco. The colour of aerosol generating non-tobacco may be, for example, white, green, red, purple, blue, brown or black. Other colours are also envisaged. Natural or synthetic colourants, such as natural or synthetic dyes, food-grade colourants and pharmaceutical-grade colourants may be used. In certain embodiments, the colourant is caramel, which may confer the aerosol generating non-tobacco with a brown appearance. In such embodiments, the colour of the aerosol generating non-tobacco may be similar to the colour of other components (such as tobacco material) in an aerosol-generating material comprising the aerosol generating non-tobacco. In some embodiments, the addition of a colourant to the aerosol generating non-tobacco renders it visually indistinguishable from other components in the aerosol-generating material.

The colourant may be incorporated during the formation of the aerosol generating non-tobacco (e.g. when forming a slurry comprising the materials that form the aerosol generating non-tobacco) or it may be applied to the aerosol generating non-tobacco after its formation (e.g. by spraying it onto the aerosol generating non-tobacco).

The one or more other functional materials may comprise one or more of pH regulators, colouring agents, preservatives, binders, fillers, stabilizers, and/or antioxidants.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Articles, for instance those in the shape of rods, are often named according to the product length: “regular” (typically in the range 68-75 mm, e.g. from about 68 mm to about 72 mm), “short” or “mini” (68 mm or less), “king-size” (typically in the range 75 91 mm, e.g. from about 79 mm to about 88 mm), “long” or “super-king” (typically in the range 91-105 mm, e.g. from about 94 mm to about 101 mm) and “ultra-long” (typically in the range from about 110 mm to about 121 mm).

They are also named according to the product circumference: “regular” (about 23-25 mm), “wide” (greater than 25 mm), “slim” (about 22-23 mm), “demi-slim” (about 19-22 mm), “super-slim” (about 16-19 mm), and “micro-slim” (less than about 16 mm). Accordingly, an article in a king-size, super-slim format will, for example, have a length of about 83 mm and a circumference of about 17 mm.

Each format may be produced with mouthpieces of different lengths. The mouthpiece length will be from about 30 mm to 50 mm. A tipping paper connects the mouthpiece to the aerosol-generating material and will usually have a greater length than the mouthpiece, for example from 3 to 10 mm longer, such that the tipping paper covers the mouthpiece and overlaps the aerosol-generating material, for instance in the form of a rod of substrate material, to connect the mouthpiece to the rod.

Articles and their aerosol-generating materials and mouthpieces described herein can be made in, but are not limited to, any of the above formats.

The terms ‘upstream’ and ‘downstream’ used herein are relative terms defined in relation to the direction of mainstream aerosol drawn though an article or device in use.

The filamentary tow material described herein can comprise cellulose acetate fibre tow. The filamentary tow can also be formed using other materials used to form fibres, such as polyvinyl alcohol (PVOH), polylactic acid (PLA), polycaprolactone (PCL), poly(1-4 butanediol succinate) (PBS), poly(butylene adipate-co-terephthalate)(PBAT), starch based materials, cotton, aliphatic polyester materials and polysaccharide polymers or a combination thereof. The filamentary tow may be plasticised with a suitable plasticiser for the tow, such as triacetin where the material is cellulose acetate tow, or the tow may be non-plasticised. The tow can have any suitable specification, such as fibres having a ‘Y’ shaped or other cross section such as ‘X’ shaped, filamentary denier values between 2.5 and 15 denier per filament, for example between 8.0 and 11.0 denier per filament and total denier values of 5,000 to 50,000, for example between 10,000 and 40,000.

Aerosol generating material described herein may comprise a plurality of strips of another non-tobacco material in addition to the examples of aerosol generating non-tobacco material. This non-tobacco material (referred to herein as the ‘other non-tobacco material’ may or may not have aerosol generating properties. In some examples, the other non-tobacco material comprises a reconstituted fibrous or cellulose material, such as paper. The other non-tobacco material is provided as a sheet material which is then shredded or cut into a plurality of strips as described below. Alternatively, the other non-tobacco material may be shredded organic non-tobacco material. In one such alternative example, the shredded organic non-tobacco material is a botanical material, for example rooibos.

The term ‘paper’ is considered to include any sheet material formed as a result of a papermaking process. Such processes are well known to the skilled person and include the following steps:
forming a dilute suspension of a filler material in water or a binder; or, forming a fibrous pulp;
screening or sieving dry the resulting solution; and
pressing the resulting solution to form a sheet material.

Filler materials that may be pressed into a sheet for forming the other non-tobacco material include wood pulp, botanical material, ground cellulose, microcrystalline cellulose and chalk. In one example the filler material comprises an organic non-tobacco material. In one example the organic non-tobacco filler material is rooibos.

In some examples, the other non-tobacco material contains an aerosol-former material. In some embodiments, the aerosol-former material of the other non-tobacco material may be glycerol, propylene glycol, or a mixture of glycerol and propylene glycol. Glycerol may be present in an amount of from 10 to 20 % by weight of the other non-tobacco material, for example 13 to 16 % by weight of the composition, i.e. the overall aerosol-generating material described herein, or about 14% or 15% by weight of the composition. Propylene glycol, if present, may be present in an amount of from 0.1 to 0.3% by weight of the composition.

The aerosol-former material may be included in any component of the other non-tobacco material, if present. Alternatively or additionally the aerosol-former material may be added to the other non-tobacco material separately. In either case, the total amount of the aerosol-former material in the other non-tobacco material can be as defined herein.

In some embodiments, the other non-tobacco material comprises nicotine. In some embodiments the nicotine is present in an amount of from 1% to 10% by weight of the other non-tobacco material, for example 3% to 7% by weight of the other non-tobacco material. In one embodiment, the nicotine is present in an amount of 5% by weight of the other non-tobacco material.

In some embodiments, the other non-tobacco material comprises a binder. In some embodiments the binder is present in an amount of from 5% to 15% by weight of the other non-tobacco material, for example 7% to 12% by weight of the other non-tobacco material. In one embodiment, the binder is present in an amount of 10% by weight of the other non-tobacco material.

In one embodiment, the other non-tobacco material comprises:
nicotine in an amount of 5% by weight of the other non-tobacco material;
a binder in an amount of 10% by weight of the other non-tobacco material;
glycerol in an amount of 20% by eight of the other non-tobacco material; and
a filler material.

In one embodiment, the other non-tobacco material comprises:
nicotine in an amount of 5% by weight of the other non-tobacco material;
an acid in an amount of 5% by weight of the other non-tobacco material;
a binder in an amount of 10% by weight of the other non-tobacco material;
glycerol in an amount of 20% by eight of the other non-tobacco material; and
a filler material.

In the compositions or aerosol-generating materials described herein, where amounts are given in % by weight, for the avoidance of doubt this refers to a dry weight basis, unless specifically indicated to the contrary. Thus, any water that may be present in the aerosol generating materials, or in any component thereof, is entirely disregarded for the purposes of the determination of the weight %.

In the figures described herein, like reference numerals are used to illustrate equivalent features, articles or components.

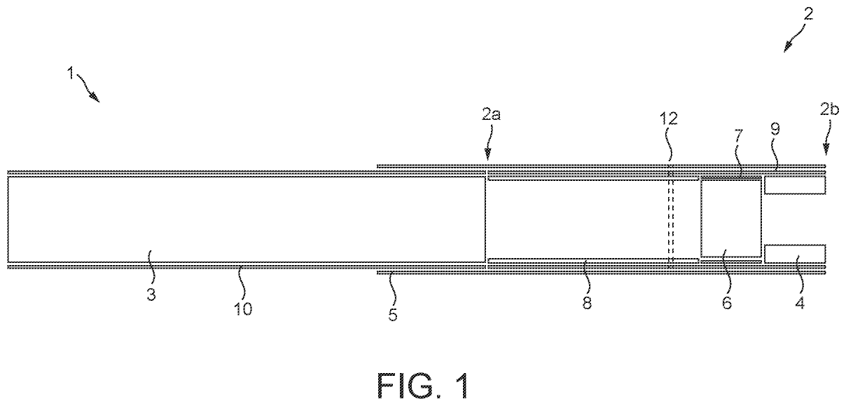

FIG. 1 is a side-on cross sectional view of an article 1 for use in an aerosol delivery system.

The article 1 comprises a mouthpiece 2 and a cylindrical rod of aerosol-generating material 3 forming an aerosol generating section of the article 1, connected to the mouthpiece 2. In embodiments of the invention the aerosol-generating material comprises a blend of at least two distinct components comprising a plurality of strands and/or strips of an aerosol generating non-tobacco material and a plurality of strips of another non-tobacco material. In an exemplary embodiment, the plurality of strands and/or strips of aerosol generating non-tobacco material and the plurality of strips of the other non-tobacco material each have a length of at least about 5 mm. In some embodiments, the material properties and/or dimensions of the at least two components may be suitably selected in other ways, to ensure a relatively uniform mix of the components is possible, and to reduce separation or un-mixing of the components during or after manufacture of the rod of aerosol-generating material.

Although described above in rod form, the aerosol-generating material can be provided in other forms, for instance a plug, pouch, or packet of material within an article. The article can comprise a consumable for an aerosol delivery or provision system such as a non-combustible aerosol delivery or provision system as described herein.

In the present example a first component is an aerosol generating non-tobacco material, and a second component is another non-tobacco material.

In the some examples, the other non-tobacco material comprises paper. The other non-tobacco material can alternatively or additionally comprise any of the forms described herein.

In one example, the other non-tobacco material comprises a substrate and an aerosol-former material provided in an amount of up to about 10% by weight of the substrate. Such aerosol-former can be provided in addition to aerosol-former provided in the aerosol generating non-tobacco material. For instance, between 3% and 8% aerosol-former by weight of the other non-tobacco material can be used, or between 4% and 7%, or between 5% and 7%. The remainder of the other non-tobacco material can comprise paper.

In the present example the aerosol generating non-tobacco material is a dried gel comprising menthol. In alternative embodiments, the aerosol generating non-tobacco may have any composition as described herein.

The inventors have advantageously found that an improved article may be produced comprising aerosol-generating material comprising a first component comprising an aerosol generating non-tobacco material and a second component comprising another non-tobacco material, wherein the material properties (e.g. density) and specification (e.g. thickness, length, and cut width) fall within the ranges set out herein.

In some cases, the aerosol generating non-tobacco material may have a thickness of about 0.015 mm to about 1.5 mm. Suitably, the thickness may be in the range of about 0.05 mm, 0.1 mm or 0.15 mm to about 0.5 mm, 0.3 mm, or 1 mm. The inventors have found that a material having a thickness of about 0.2 mm can be used. The aerosol generating non-tobacco material may comprise more than one layer, and the thickness described herein refers to the aggregate thickness of those layers.

The thickness of the aerosol generating non-tobacco material may be measured using a calliper or a microscope such as a scanning electron microscope (SEM), as known to those skilled in the art, or any other suitable technique known to those skilled in the art.

The inventors have established that if the aerosol generating non-tobacco material is too thick, then heating efficiency can be compromised. This can adversely affect power consumption in use, for instance the power consumption for release of flavour from the aerosol generating non-tobacco material. Conversely, if the aerosol-forming aerosol generating non-tobacco material is too thin, it can be difficult to manufacture and handle; a very thin material can be harder to cast and may be fragile, compromising aerosol formation in use. The inventors have established that the aerosol generating non-tobacco material thicknesses stipulated herein optimise the material properties in view of these competing considerations.

In some cases, an individual strip or piece of the aerosol generating non-tobacco material has a minimum thickness over its area of about 0.015 mm. In some cases, an individual strip or piece of the aerosol generating non-tobacco material has a minimum thickness over its area of about 0.05 mm or about 0.1 mm. In some cases, an individual strip or piece of the aerosol generating non-tobacco material has a maximum thickness over its area of about 1.0 mm. In some cases, an individual strip or piece of the aerosol generating non-tobacco material has a maximum thickness over its area of about 0.5 mm or about 0.3 mm.

The inventors have found that providing aerosol generating non-tobacco material and another non-tobacco material having area density values that differ from each other by less than a given percentage results in less separation in a mixture of these materials. In some examples, the area density of the aerosol generating non-tobacco material may be between 50% and 150% of the area density of the other non-tobacco material. For instance, the area density of the aerosol generating non-tobacco material may be between 60% and 140% of the density of the other non-tobacco material, or between 70% and 110% of the area density of the other non-tobacco material, or between 80% and 120% of the area density of the other non-tobacco material.

For the avoidance of doubt, where reference is made herein to area density, this refers to an average area density calculated for a given strip, piece or sheet of aerosol generating non-tobacco material, the area density calculated by measuring the surface area and weight of the given strip, piece or sheet of aerosol generating non-tobacco material.

In some cases, the aerosol generating non-tobacco material thickness may vary by no more than 25%, 20%, 15%, 10%, 5% or 1% across its area.

In embodiments described herein, the aerosol generating non-tobacco material may be incorporated into the article in sheet form. The aerosol generating non-tobacco material in sheet form may be shredded and then incorporated into the article, suitably mixed into an aerosolisable material (as described further hereinbelow).

In further embodiments the aerosol generating non-tobacco sheet may additionally be incorporated as a planar sheet, as a gathered or bunched sheet, as a crimped sheet, or as a rolled sheet (i.e. in the form of a tube). In some such cases, the aerosol generating non-tobacco of these embodiments may be included in an aerosol-generating article as a sheet, such as a sheet circumscribing a rod of aerosolisable material (e.g. tobacco). For example, the aerosol generating non-tobacco sheet may be formed on a wrapping paper which circumscribes an aerosolisable material such as tobacco.

The aerosol generating non-tobacco in sheet form may have any suitable area density, such as from about 30 g/m² to about 150 g/m². In some cases, the sheet may have a mass per unit area of about 55 g/m² to about 135 g/m² , or about 80 to about 120 g/m², or from about 70 to about 110 g/m², or from about 100 g/m² to about 125 g/m², or particularly from about 90 to about 110 g/m², or suitably about 100 g/m², 120 g/m² or 110 g/m². These ranges can provide a density which is similar to the density of cut rag tobacco and as a result a mixture of these substances can be provided which will not readily separate. Such area densities may be particularly suitable where the aerosol generating non-tobacco material is included in an aerosol-generating article as a shredded sheet (described further hereinbelow). In some cases, the sheet may have a mass per unit area of about 30 to 70 g/m², 40 to 60 g/m², or 25 to 60 g/m² and may be used to wrap an aerosolisable material such as tobacco.

The density of the aerosol generating material has an impact on the speed at which heat conducts through the material, with lower densities, for instance those below 700 mg/cc, conducting heat more slowly through the material, and therefore enabling a more sustained release of aerosol.

The other non-tobacco material can comprise a density of less than about 700 mg/cc, for instance a paper material. For instance, the aerosol-generating material 3 comprises a paper having a density of less than about 600 mg/cc. Alternatively or in addition, the aerosol-generating material 3 can comprise a paper material having a density of at least 350 mg/cc.

The other non-tobacco material may be provided in a form to mimic cut rag tobacco. For example, the non-tobacco material may be paper cut into sections of similar size, shape, thickness and/or density to typical cut rag tobacco. The paper can have a cut width of at least 15 cuts per inch (about 5.9 cuts per cm, equivalent to a cut width of about 1.7 mm). Preferably, the paper has a cut width of at least 18 cuts per inch (about 7.1 cuts per cm, equivalent to a cut width of about 1.4 mm), more preferably at least 20 cuts per inch (about 7.9 cuts per cm, equivalent to a cut width of about 1.27 mm). In one example, the paper has a cut width of 22 cuts per inch (about 8.7 cuts per cm, equivalent to a cut width of about 1.15 mm). Preferably, the paper has a cut width at or below 40 cuts per inch (about 15.7 cuts per cm, equivalent to a cut width of about 0.64 mm). Cut widths between 0.5 mm and 2.0 mm, for instance between 0.6 and 1.7 mm or between 0.6 mm and 1.5 mm, have been found to result in a non-tobacco material which is preferable in terms of surface area to volume ratio, particularly when heated; and also preferable in terms of the overall density and pressure drop of the rod of aerosol-generating material 3.

The other non-tobacco material may have any suitable thickness. The other non-tobacco material may have a thickness of at least about 0.145 mm, for instance at least about 0.15 mm, or at least about 0.16 mm. The other non-tobacco material may have a maximum thickness of about 0.25 mm, for instance the thickness of the other non-tobacco material may be less than about 0.22 mm, or less than about 0.2 mm. In some embodiments, the other non-tobacco material may have an average thickness in the range 0.175 mm to 0.195 mm. Such thicknesses may be particularly suitable where the other non-tobacco material is a paper material.

It can be desirable to provide an aerosol-generating material comprising a blend of at least two components, such as a first component comprising the aerosol generating non-tobacco material and a second component comprising other non-tobacco material as described herein. Such aerosol-generating material can provide an aerosol, in use, with a desirable flavour profile, since additional flavour may be introduced to the aerosol-generating material by inclusion in the aerosol generating non-tobacco material component. Flavour provided in the aerosol generating non-tobacco material may be more stably retained within the aerosol generating non-tobacco material compared to flavour added directly to a substrate material such as paper or reconstituted tobacco sheets, resulting in a more consistent flavour profile between articles produced according to this invention.

As described above, the other non-tobacco material having a density of at least 350 mg/cc and less than about 700 mg/cc has been advantageously found to result in a more sustained release of aerosol when incorporated into an aerosol generating material 3 as described herein. To provide an aerosol having a consistent flavour profile the aerosol generating non-tobacco material component of the aerosol-generating material should be evenly distributed throughout the rod. The inventors have advantageously found that this can be achieved by casting the aerosol generating non-tobacco material to have a thickness as described herein, to provide an aerosol generating non-tobacco material having an area density which is similar to the area density of the other non-tobacco material, and processing the aerosol generating non-tobacco material as described hereinbelow to ensure an even distribution throughout the aerosol-generating material.

The inventors have advantageously found that sufficiently even mixing of the aerosol generating non-tobacco material component and the other non-tobacco material component can be achieved when the aerosol generating non-tobacco material in sheet form is shredded. Preferably the cut width of the shredded aerosol generating non-tobacco material is between 0.75 mm and 2 mm, for instance between 1 mm and 1.5 mm. The strands of aerosol generating non-tobacco material formed by shredding may be cut width-wise, for example in a cross-cut type shredding process, to define a cut length for the shredded aerosol generating non-tobacco material, in addition to a cut width. The cut length of the shredded aerosol generating non-tobacco material is preferably at least 5 mm, for instance at least 10 mm, or at least 20 mm. The cut length of the shredded aerosol generating non-tobacco material can be less than 60 mm, less than 50 mm, or less than 40 mm. The inventors have advantageously found that to achieve even mixing of the shredded aerosol generating non-tobacco material with the other non-tobacco material, the cut length of the shredded aerosol generating non-tobacco material is preferably non-uniform. For example, the distribution of cut lengths may be a multi-modal distribution, such as a bimodal distribution. In some examples, a first portion of aerosol generating non-tobacco material may be cut to a first length, and a second portion of aerosol generating non-tobacco material may be cut to a second length, and the cut material mixed together to form a plurality of strands or strips of aerosol generating non-tobacco material having a bimodal distribution of lengths. In some examples, the first cut length may be from 30 mm to 50 mm, or 35 mm for 45 mm, or about 40 mm, and the second cut length may be from 10 mm to 30 mm, or from 15 mm to 25 mm, or about 20 mm. The number of cut lengths may be selected to match the number of modes in the distribution of lengths of a shredded tobacco material. The strands of aerosol generating non-tobacco material having different cut lengths may be mixed together in a ratio selected to match the distribution of lengths of the shredded other non-tobacco material. The inventors have found that matching the distribution of lengths of the strands and/or strips of aerosol generating non-tobacco material to the distribution of lengths of the strands of the other non-tobacco material can result in a more even mixing of the aerosol generating non-tobacco with the other non-tobacco material.

Although referred to as cut length, the length of the shreds or strips of aerosol generating non-tobacco material can alternatively or additionally be dictated by a dimension of the material determined during its manufacture, for instance the width of a sheet of the material as manufactured.

In some embodiments, a plurality of strips of aerosol generating non-tobacco is provided and at least one of the plurality of strips of aerosol generating non-tobacco material has a length greater than about 10 mm. At least one of the plurality of strips of aerosol generating non-tobacco material can alternatively or in addition have a length between about 10 mm and about 60 mm, or between about 20 mm and about 50 mm. Each of the plurality of strips of aerosol generating non-tobacco material can have a length between about 10 mm and about 60 mm, or between about 20 mm and about 50 mm.

Preferably, the rod of aerosol generating material comprises a first component comprising a non-tobacco aerosol generating material as defined herein in an amount from 10 % to 90 %, by weight of the total aerosol generating material 3 and a second component—being the other non-tobacco material as defined herein-in an amount making up the remainder of the total aerosol generating material. Preferably, the first component is provided in an amount of between 50 mg and 300 mg, for example between 100 mg and 150 mg.

The inventors have found that it can be advantageous for manufacturing to form the rod of aerosol generating material from a relatively low amount, within the ranges set out herein, of shredded aerosol generating non-tobacco material comprising a relatively high level of aerosol-former, within the ranges set out herein, such that for a given aerosol-former content in the aerosol generating material, a lower number of the plurality of strips of aerosol generating non-tobacco material are required. This can be beneficial for manufacture because relatively more of the other non-tobacco material comes into contact with components of the manufacturing machinery compared to the aerosol generating non-tobacco material, which can reduce the likelihood of material clumping on the machinery and/or blockages forming during manufacture. For instance, the amount of aerosol-former, such as glycerol, in the aerosol generating non-tobacco material can comprise between 20% and 70%, for instance between 25% and 55%, between 30% and 40% or between 45% and 55% by weight of the aerosol generating non-tobacco material.

The inventors have advantageously found that aerosol-generating material according to the present disclosure can have a more uniform distribution of the shredded aerosol generating non-tobacco material throughout the aerosol-generating material. For instance, the standard deviation (expressed as a percentage of the mean) in the percentage weight inclusion level of the strips of aerosol generating non-tobacco material in the aerosol-generating material between consumables made using the aerosol generating material as described herein can be less than 35%, or less than 30% by weight of the aerosol-generating material, based on a measurement of 10 consumables in the present case each containing about 650 mg of the aerosol-generating material. In aerosol-generating materials produced according to the present disclosure, the standard deviation in the total glycerol content within a given batch of material was less than 35% of the mean in all cases, or less than 30% or less than 25%.

Where the aerosol generating non-tobacco material comprises a flavourant, the total flavourant in the article may comprise the flavourant provided in the aerosol generating non-tobacco material, and optionally further flavourant applied to the other non-tobacco material or present in a component of the article other than the aerosol-generating material 3. The total flavourant content of the article may be determined by deconstructing the article into its component parts and performing chemical analysis as known to those skilled in the art to determine the flavourant content of each component, and thereby the total flavourant content. In examples where the aerosol generating non-tobacco comprises a flavourant, the total flavourant content of the article may be between 5 mg and 30 mg per article, for instance between 16 mg and 22 mg per article, or between 5 mg and 10 mg per article or between 17 mg and 30 mg per article. The aerosol generating non-tobacco may comprise at least 20% of the total flavourant content.

Articles comprising aerosol-generating material according to the present disclosure may include 5 wt %, 12 wt % or 20 wt % aerosol generating non-tobacco comprising 35 wt % menthol as a flavourant.

The aerosol-generating material can be provided in the form of a rod having a first end and a second end. The portion of the rod between the first end of the rod and a longitudinal position half-way between the first and second ends can include from 20% to 80% of the aerosol generating non-tobacco material in the rod.

The mouthpiece 2, in the present example, includes a body of material 6 upstream of the hollow tubular element 4, in this example adjacent to and in an abutting relationship with the hollow tubular element 4. The body of material 6 and hollow tubular element 4 each define a substantially cylindrical overall outer shape and share a common longitudinal axis. The body of material 6 is wrapped in a first plug wrap 7.

Preferably, the first plug wrap 7 has a basis weight of less than 50 gsm, more preferably between about 20 gsm and 40 gsm. Preferably, the first plug wrap 7 has a thickness of between 30 μm and 60 μm, more preferably between 35 μm and 45 μm. Preferably, the first plug wrap 7 is a non-porous plug wrap, for instance having a permeability of less than 100 Coresta units, for instance less than 50 Coresta units. However, in other embodiments, the first plug wrap 7 can be a porous plug wrap, for instance having a permeability of greater than 200 Coresta Units.

Preferably, the length of the body of material 6 is less than about 15 mm. More preferably, the length of the body of material 6 is less than about 10 mm. In addition, or as an alternative, the length of the body of material 6 is at least about 5 mm. Preferably, the length of the body of material 6 is at least about 6 mm. In some preferred embodiments, the length of the body of material 6 is from about 5 mm to about 15 mm, more preferably from about 6 mm to about 12 mm, even more preferably from about 6 mm to about 12 mm, most preferably about 6 mm, 7 mm, 8 mm, 9 mm or 10 mm. In the present example, the length of the body of material 6 is 10 mm.

In the present example, the body of material 6 is formed from filamentary tow. In the present example, the tow used in the body of material 6 has a denier per filament (d.p.f.) of 8.4 and a total denier of 21,000. Alternatively, the tow can, for instance, have a denier per filament (d.p.f.) of 9.5 and a total denier of 12,000. In the present example, the tow comprises plasticised cellulose acetate tow. The plasticiser used in the tow comprises about 7% by weight of the tow. In the present example, the plasticiser is triacetin. In other examples, different materials can be used to form the body of material 6. For instance, rather than tow, the body 6 can be formed from paper, for instance in a similar way to paper filters known for use in cigarettes. Alternatively, the body 6 can be formed from tows other than cellulose acetate, for instance polylactic acid (PLA), other materials described herein for filamentary tow or similar materials. The tow is preferably formed from cellulose acetate. The tow, whether formed from cellulose acetate or other materials, preferably has a d.p.f. of at least 5, more preferably at least 6 and still more preferably at least 7. These values of denier per filament provide a tow which has relatively coarse, thick fibres with a lower surface area which result in a lower pressure drop across the mouthpiece 2 than tows having lower d.p.f. values. Preferably, to achieve a sufficiently uniform body of material 6, the tow has a denier per filament of no more than 12 d.p.f., preferably no more than 11 d.p.f. and still more preferably no more than 10 d.p.f.

The total denier of the tow forming the body of material 6 is preferably at most 30,000, more preferably at most 28,000 and still more preferably at most 25,000. These values of total denier provide a tow which takes up a reduced proportion of the cross sectional area of the mouthpiece 2 which results in a lower pressure drop across the mouthpiece 2 than tows having higher total denier values. For appropriate firmness of the body of material 6, the tow preferably has a total denier of at least 8,000 and more preferably at least 10,000. Preferably, the denier per filament is between 5 and 12 while the total denier is between 10,000 and 25,000. More preferably, the denier per filament is between 6 and 10 while the total denier is between 11,000 and 22,000. Preferably the cross-sectional shape of the filaments of tow are ‘Y’ shaped, although in other embodiments other shapes such as ‘X’ shaped filaments can be used, with the same d.p.f. and total denier values as provided herein.

As shown in FIG. 1, the mouthpiece 2 of the article 1 comprises an upstream end 2a adjacent to the rod of aerosol-generating material 3 and a downstream end 2b distal from the rod of aerosol-generating material 3. At the downstream end 2b, the mouthpiece 2 has a hollow tubular element 4 formed from filamentary tow. This has advantageously been found to significantly reduce the temperature of the outer surface of the mouthpiece 2 at the downstream end 2b of the mouthpiece which comes into contact with a consumer's mouth when the article 1 is in use. In addition, the use of the tubular element 4 has also been found to significantly reduce the temperature of the outer surface of the mouthpiece 2 even upstream of the tubular element 4. Without wishing to be bound by theory, it is hypothesised that this is due to the tubular element 4 channelling aerosol closer to the centre of the mouthpiece 2, and therefore reducing the transfer of heat from the aerosol to the outer surface of the mouthpiece 2.

In the present example, the article 1 has an outer circumference of about 21 mm (i.e. the article is in the demi-slim format). In other examples, the article can be provided in any of the formats described herein, for instance having an outer circumference of between 15 mm and 25 mm. Since the article is to be heated to release an aerosol, improved heating efficiency can be achieved using articles having lower outer circumferences within this range, for instance circumferences of less than 23 mm. To achieve improved aerosol via heating, while maintaining a suitable product length, article circumferences of greater than 19 mm have also been found to be particularly effective. Articles having circumferences of between 19 mm and 23 mm, and more preferably between 20 mm and 22 mm, have been found to provide a good balance between providing effective aerosol delivery while allowing for efficient heating.

The outer circumference of the mouthpiece 2 is substantially the same as the outer circumference of the rod of aerosol-generating material 3, such that there is a smooth transition between these components. In the present example, the outer circumference of the mouthpiece 2 is about 20.8 mm. A tipping paper 5 is wrapped around the full length of the mouthpiece 2 and over part of the rod of aerosol-generating material 3 and has an adhesive on its inner surface to connect the mouthpiece 2 and rod 3. In the present example, the tipping paper 5 extends 5 mm over the rod of aerosol-generating material 3 but it can alternatively extend between 3 mm and 10 mm over the rod 3, or more preferably between 4 mm and 6 mm, to provide a secure attachment between the mouthpiece 2 and rod 3. The tipping paper 5 can have a basis weight which is higher than the basis weight of plug wraps used in the article 1, for instance a basis weight of 40 gsm to 80 gsm, more preferably between 50 gsm and 70 gsm, and in the present example 58 gsm. These ranges of basis weights have been found to result in tipping papers having acceptable tensile strength while being flexible enough to wrap around the article 1 and adhere to itself along a longitudinal lap seam on the paper. The outer circumference of the tipping paper 5, once wrapped around the mouthpiece 2, is about 21 mm.

The “wall thickness” of the hollow tubular element 4 corresponds to the thickness of the wall of the tube 4 in a radial direction. This may be measured, for example, using a calliper. The wall thickness is advantageously greater than 0.9 mm, and more preferably 1.0 mm or greater. Preferably, the wall thickness is substantially constant around the entire wall of the hollow tubular element 4. However, where the wall thickness is not substantially constant, the wall thickness is preferably greater than 0.9 mm at any point around the hollow tubular element 4, more preferably 1.0 mm or greater.

Preferably, the length of the hollow tubular element 4 is less than about 20 mm. More preferably, the length of the hollow tubular element 4 is less than about 15 mm. Still more preferably, the length of the hollow tubular element 4 is less than about 10 mm. In addition, or as an alternative, the length of the hollow tubular element 4 is at least about 5 mm. Preferably, the length of the hollow tubular element 4 is at least about 6 mm. In some preferred embodiments, the length of the hollow tubular element 4 is from about 5 mm to about 20 mm, more preferably from about 6 mm to about 10 mm, even more preferably from about 6 mm to about 8 mm, most preferably about 6 mm, 7 mm or about 8 mm. In the present example, the length of the hollow tubular element 4 is 6 mm.

Preferably, the density of the hollow tubular element 4 is at least about 0.25 grams per cubic centimetre (g/cc), more preferably at least about 0.3 g/cc. Preferably, the density of the hollow tubular element 4 is less than about 0.75 grams per cubic centimetre (g/cc), more preferably less than 0.6 g/cc. In some embodiments, the density of the hollow tubular element 4 is between 0.25 and 0.75 g/cc, more preferably between 0.3 and 0.6 g/cc, and more preferably between 0.4 g/cc and 0.6 g/cc or about 0.5 g/cc. These densities have been found to provide a good balance between improved firmness afforded by denser material and the lower heat transfer properties of lower density material. For the purposes of the present invention, the “density” of the hollow tubular element 4 refers to the density of the filamentary tow forming the element with any plasticiser incorporated. The density may be determined by dividing the total weight of the hollow tubular element 4 by the total volume of the hollow tubular element 4, wherein the total volume can be calculated using appropriate measurements of the hollow tubular element 4 taken, for example, using callipers. Where necessary, the appropriate dimensions may be measured using a microscope.

The filamentary tow forming the hollow tubular element 4 preferably has a total denier of less than 45,000, more preferably less than 42,000. This total denier has been found to allow the formation of a tubular element 4 which is not too dense. Preferably, the total denier is at least 20,000, more preferably at least 25,000. In preferred embodiments, the filamentary tow forming the hollow tubular element 4 has a total denier between 25,000 and 45,000, more preferably between 35,000 and 45,000. Preferably the cross-sectional shape of the filaments of tow are ‘Y’ shaped, although in other embodiments other shapes such as ‘X’ shaped filaments can be used.

The filamentary tow forming the hollow tubular element 4 preferably has a denier per filament of greater than 3. This denier per filament has been found to allow the formation of a tubular element 4 which is not too dense. Preferably, the denier per filament is at least 4, more preferably at least 5. In preferred embodiments, the filamentary tow forming the hollow tubular element 4 has a denier per filament between 4 and 10, more preferably between 4 and 9. In one example, the filamentary tow forming the hollow tubular element 4 has an 8Y40,000 tow formed from cellulose acetate and comprising 18% plasticiser, for instance triacetin.

The hollow tubular element 4 preferably has an internal diameter of greater than 3.0 mm. Smaller diameters than this can result in increasing the velocity of aerosol passing though the mouthpiece 2 to the consumers mouth more than is desirable, such that the aerosol becomes too warm, for instance reaching temperatures greater than 40° C. or greater than 45° C. More preferably, the hollow tubular element 4 has an internal diameter of greater than 3.1 mm, and still more preferably greater than 3.5 mm or 3.6 mm. In one embodiment, the internal diameter of the hollow tubular element 4 is about 3.9 mm.

The hollow tubular element 4 preferably comprises from 15% to 22% by weight of plasticiser. For cellulose acetate tow, the plasticiser is preferably triacetin, although other plasticisers such as polyethelyne glycol (PEG) can be used. More preferably, the tubular element 4 comprises from 16% to 20% by weight of plasticiser, for instance about 17%, about 18% or about 19% plasticiser.

In the present example the hollow tubular element 4 is a first hollow tubular element 4 and the mouthpiece includes a second hollow tubular element 8, also referred to as a cooling element, upstream of the first hollow tubular element 4. In the present example, the second hollow tubular element 8 is upstream of, adjacent to and in an abutting relationship with the body of material 6. The body of material 6 and second hollow tubular element 8 each define a substantially cylindrical overall outer shape and share a common longitudinal axis. The second hollow tubular element 8 is formed from a plurality of layers of paper which are parallel wound, with butted seams, to form the tubular element 8. In the present example, first and second paper layers are provided in a two-ply tube, although in other examples 3, 4 or more paper layers can be used forming 3, 4 or more ply tubes. Other constructions can be used, such as spirally wound layers of paper, cardboard tubes, tubes formed using a papier-mâché type process, moulded or extruded plastic tubes or similar. The second hollow tubular element 8 can also be formed using a stiff plug wrap and/or tipping paper as the second plug wrap 9 and/or tipping paper 5 described herein, meaning that a separate tubular element is not required. The stiff plug wrap and/or tipping paper is manufactured to have a rigidity that is sufficient to withstand the axial compressive forces and bending moments that might arise during manufacture and whilst the article 1 is in use. For instance, the stiff plug wrap and/or tipping paper can have a basis weight between 70 gsm and 120 gsm, more preferably between 80 gsm and 110 gsm. Additionally or alternatively, the stiff plug wrap and/or tipping paper can have a thickness between 80 um and 200 μm, more preferably between 100 μm and 160 μm, or from 120 μm to 150 μm. It can be desirable for both the second plug wrap 9 and tipping paper 5 to have values in these ranges, to achieve an acceptable overall level of rigidity for the second hollow tubular element 8.

The second hollow tubular element 8 preferably has a wall thickness, which can be measured in the same way as that of the first hollow tubular element 4, of at least about 100 μm and up to about 1.5 mm, preferably between 100 μm and 1 mm and more preferably between 150 μm and 500 μm, or about 300 μm. In the present example, the second hollow tubular element 8 has a wall thickness of about 290 μm.

Preferably, the length of the second hollow tubular element 8 is less than about 50 mm. More preferably, the length of the second hollow tubular element 8 is less than about 40 mm. Still more preferably, the length of the second hollow tubular element 8 is less than about 30 mm. In addition, or as an alternative, the length of the second hollow tubular element 8 is preferably at least about 10 mm. Preferably, the length of the second hollow tubular element 8 is at least about 15 mm. In some preferred embodiments, the length of the second hollow tubular element 8 is from about 20 mm to about 30 mm, more preferably from about 22 mm to about 28 mm, even more preferably from about 24 to about 26 mm, most preferably about 25 mm. In the present example, the length of the second hollow tubular element 8 is 25 mm.

The second hollow tubular element 8 is located around and defines an air gap within the mouthpiece 2 which acts as a cooling segment. The air gap provides a chamber through which heated volatilised components generated by the aerosol-generating material 3 flow. The second hollow tubular element 8 is hollow to provide a chamber for aerosol accumulation yet rigid enough to withstand axial compressive forces and bending moments that might arise during manufacture and whilst the article 1 is in use. The second hollow tubular element 8 provides a physical displacement between the aerosol-generating material 3 and the body of material 6. The physical displacement provided by the second hollow tubular element 8 will provide a thermal gradient across the length of the second hollow tubular element 8.

Preferably, the mouthpiece 2 comprises a cavity having an internal volume greater than 450 mm³. Providing a cavity of at least this volume has been found to enable the formation of an improved aerosol. Such a cavity size provides sufficient space within the mouthpiece 2 to allow heated volatilised components to cool, therefore allowing the exposure of the aerosol-generating material 3 to higher temperatures than would otherwise be possible, since they may result in an aerosol which is too warm. In the present example, the cavity is formed by the second hollow tubular element 8, but in alternative arrangements it could be formed within a different part of the mouthpiece 2. More preferably, the mouthpiece 2 comprises a cavity, for instance formed within the second hollow tubular element 8, having an internal volume greater than 500 mm³, and still more preferably greater than 550 mm³, allowing further improvement of the aerosol. In some examples, the internal cavity comprises a volume of between about 550 mm³ and about 750 mm³, for instance about 600 mm³ or 700 mm³.

The second hollow tubular element 8 can be configured to provide a temperature differential of at least 40 degrees Celsius between a heated volatilised component entering a first, upstream end of the second hollow tubular element 8 and a heated volatilised component exiting a second, downstream end of the second hollow tubular element 8. The second hollow tubular element 8 is preferably configured to provide a temperature differential of at least 60 degrees Celsius, preferably at least 80 degrees Celsius and more preferably at least 100 degrees Celsius between a heated volatilised component entering a first, upstream end of the second hollow tubular element 8 and a heated volatilised component exiting a second, downstream end of the second hollow tubular element 8. This temperature differential across the length of the second hollow tubular element 8 protects the temperature sensitive body of material 6 from the high temperatures of the aerosol-generating material 3 when it is heated.

In alternative articles, the second hollow tubular element 8 can be replaced with an alternative cooling element, for instance an element formed from a body of material which allows aerosol to pass through it longitudinally, and which also performs the function of cooling the aerosol.

In the present example, the first hollow tubular element 4, body of material 6 and second hollow tubular element 8 are combined using a second plug wrap 9 which is wrapped around all three sections. Preferably, the second plug wrap 9 has a basis weight of less than 50 gsm, more preferably between about 20 gsm and 45 gsm.

Preferably, the second plug wrap 9 has a thickness of between 30 μm and 60 μm, more preferably between 35 μm and 45 μm. The second plug wrap 9 is preferably a non-porous plug wrap having a permeability of less than 100 Coresta Units, for instance less than 50 Coresta Units. However, in alternative embodiments, the second plug wrap 9 can be a porous plug wrap, for instance having a permeability of greater than 200 Coresta Units.

In the present example, the aerosol-generating material 3 is wrapped in a wrapper 10. The aerosol-generating material 3 comprises a plurality of strands and/or strips of the aerosol-generating non-tobacco material. In the present example, the wrapper 10 is a moisture impermeable wrapper. The plurality of strands or strips of aerosol-generating non-tobacco material may be aligned within the aerosol-generating section such that their longitudinal dimension is in parallel alignment with a longitudinal axis, X-X′ of the article 1. Alternatively, the strands or strips may generally be arranged such that their longitudinal dimension aligned is transverse to the longitudinal axis of the article. At least about 10%, 20%, 30%, 40%, 50%, 60%, 70%, 80%, 90% or 95 % of the plurality of strands or strips may be arranged such that their longitudinal dimension is in parallel alignment with the longitudinal axis of the article. A majority of the strands or strips may be arranged such that their longitudinal dimensions are in parallel alignment with the longitudinal axis of the article. In some embodiments, about 95% to about 100% of the plurality of strands or strips are arranged such that their longitudinal dimension is in parallel alignment with the longitudinal axis of the article. In some embodiments, substantially all of the strands or strips are arranged in the aerosol-generating section such that their longitudinal dimension is in parallel alignment with the longitudinal axis of the aerosol-generating section of the article.

Where the majority of the strands or strips are arranged in the aerosol-generating section such that their longitudinal axis is parallel with the longitudinal axis of the aerosol-generating section of the article, the force required to insert an aerosol generator into the aerosol-generating material can be relatively low. This can result in an article which is easier to use where the aerosol generator is a projection configured to penetrate the aersosol generating material as described below. This is because the aerosol generator may slip between the strands rather than cutting or compacting the aerosol generating material.

The wrapper 10 can, for instance, be a paper or paper-backed foil wrapper. In the present example, the wrapper 10 is substantially impermeable to air. In alternative embodiments, the wrapper 10 preferably has a permeability of less than 100 Coresta Units, more preferably less than 60 Coresta Units. It has been found that low permeability wrappers, for instance having a permeability of less than 100 Coresta Units, more preferably less than 60 Coresta Units, result in an improvement in the aerosol formation in the aerosol-generating material 3. Without wishing to be bound by theory, it is hypothesised that this is due to reduced loss of aerosol compounds through the wrapper 10. The permeability of the wrapper 10 can be measured in accordance with ISO 2965:2009 concerning the determination of air permeability for materials used as cigarette papers, filter plug wrap and filter joining paper.

In the present embodiment, the wrapper 10 comprises aluminium foil. Aluminium foil has been found to be particularly effective at enhancing the formation of aerosol within the aerosol-generating material 3. In the present example, the aluminium foil has a metal layer having a thickness of about 6 μm. In the present example, the aluminium foil has a paper backing. However, in alternative arrangements, the aluminium foil can be other thicknesses, for instance between 4 μm and 16 μm in thickness. The aluminium foil also need not have a paper backing, but could have a backing formed from other materials, for instance to help provide an appropriate tensile strength to the foil, or it could have no backing material. Metallic layers or foils other than aluminium can also be used. The total thickness of the wrapper is preferably between 20 μm and 60 μm, more preferably between 30 μm and 50 μm, which can provide a wrapper having appropriate structural integrity and heat transfer characteristics. The tensile force which can be applied to the wrapper before it breaks can be greater than 3,000 grams force, for instance between 3,000 and 10,000 grams force or between 3,000 and 4,500 grams force.

The article has a ventilation level of about 75% of the aerosol drawn through the article. In alternative embodiments, the article can have a ventilation level of between 50% and 80% of aerosol drawn through the article, for instance between 65% and 75%. In some examples, the standard deviation in the level of ventilation in a batch of articles produced according to the present disclosure is less than 5%, or less than 4% or less than 3%. For the purposes of determining the standard deviation in the ventilation level, a batch refers to at least 10 articles produced to the same specification. For instance, those articles provided in a pack of articles can be used as basis for the measurements. Such standard deviations can be achieved due to the improved blending of the aerosol generating non-tobacco material and the other non-tobacco material in aerosol-generating material produced according to the present invention, since the improved blend can result in a more consistent packing of the aerosol-generating material in the articles.

Ventilation at these levels helps to slow down the flow of aerosol drawn through the mouthpiece 2 and thereby enable the aerosol to cool sufficiently before it reaches the downstream end 2b of the mouthpiece 2. The ventilation is provided directly into the mouthpiece 2 of the article 1. In the present example, the ventilation is provided into the second hollow tubular element 8, which has been found to be particularly beneficial in assisting with the aerosol generation process. The ventilation is provided via first and second parallel rows of perforations 12, in the present case formed as laser perforations, at positions 17.925 mm and 18.625 mm respectively from the downstream, mouth-end 2b of the mouthpiece 2. These perforations pass though the tipping paper 5, second plug wrap 9 and second hollow tubular element 8. In alternative embodiments, the ventilation can be provided into the mouthpiece at other locations, for instance into the body of material 6 or first tubular element 4.

Preferably the aerosol-generating material 3 is provided as a cylindrical rod of aerosol-generating material. Irrespective of the form of the aerosol-generating material, it preferably has a length of about 10 mm to 100 mm. In some embodiments, the length of the aerosol-generating material is preferably in the range about 25 mm to 50 mm, more preferably in the range about 30 mm to 45 mm, and still more preferably about 30 mm to 40 mm.

The volume of aerosol-generating material 3 provided can vary from about 200 mm³ to about 4300 mm³, preferably from about 500 mm³ to 1500 mm³, more preferably from about 1000 mm³ to about 1300 mm³. The provision of these volumes of aerosol-generating material, for instance from about 1000 mm³ to about 1300 mm³, has been advantageously shown to achieve a superior aerosol, having a greater visibility and sensory performance compared to that achieved with volumes selected from the lower end of the range.

The mass of aerosol-generating material 3 provided can be greater than 200 mg, for instance from about 200 mg to 400 mg, preferably from about 230 mg to 360 mg, more preferably from about 250 mg to 360 mg. It has been advantageously found that providing a higher mass of aerosol-generating material results in improved sensory performance compared to aerosol generated from a lower mass of tobacco material.

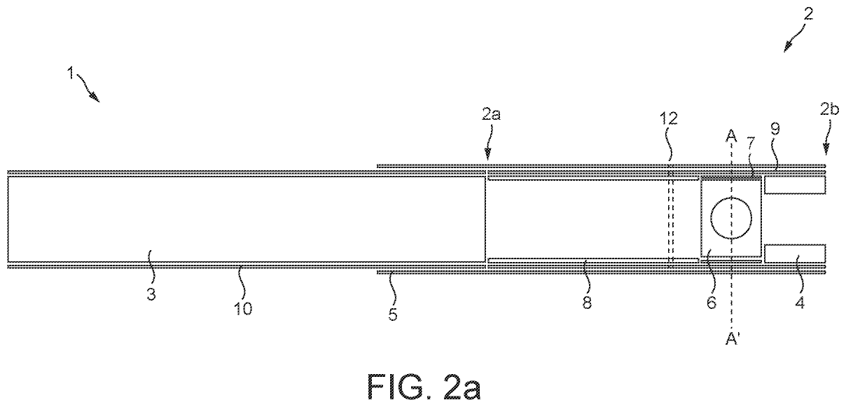

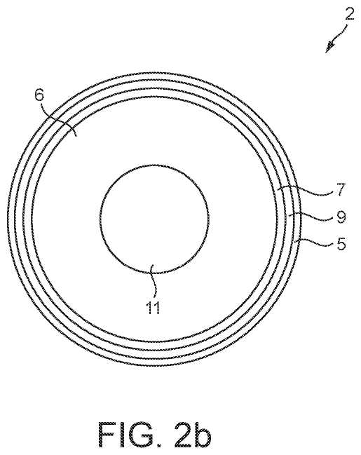

FIG. 2a is a side-on cross sectional view of a further article 1′ including a capsule-containing mouthpiece 2′. FIG. 2b is a cross sectional view of the capsule-containing mouthpiece shown in FIG. 2a through the line A-A′ thereof. Article 1′ and capsule-containing mouthpiece 2′ are the same as the article 1 and mouthpiece 2 illustrated in FIG. 1, except that an aerosol modifying agent is provided within the body of material 6, in the present example in the form of a capsule 11, and that an oil-resistant first plug wrap 7′ surrounds the body of material 6. In other examples, the aerosol modifying agent can be provided in other forms, such as material injected into the body of material 6 or provided on a thread, for instance the thread carrying a flavourant or other aerosol modifying agent, which may also be disposed within the body of material 6.

The capsule 11 can comprise a breakable capsule, for instance a capsule which has a solid, frangible shell surrounding a liquid payload. In the present example, a single capsule 11 is used. The capsule 11 is entirely embedded within the body of material 6. In other words, the capsule 11 is completely surrounded by the material forming the body 6. In other examples, a plurality of breakable capsules may be disposed within the body of material 6, for instance 2, 3 or more breakable capsules. The length of the body of material 6 can be increased to accommodate the number of capsules required. In examples where a plurality of capsules is used, the individual capsules may be the same as each other, or may differ from one another in terms of size and/or capsule payload. In other examples, multiple bodies of material 6 may be provided, with each body containing one or more capsules.

The capsule 11 has a core-shell structure. In other words, the capsule 11 comprises a shell encapsulating a liquid agent, for instance a flavourant or other agent, which can be any one of the flavourants or aerosol modifying agents described herein. The shell of the capsule can be ruptured by a user to release the flavourant or other agent into the body of material 6. The first plug wrap 7′ can comprise a barrier coating to make the material of the plug wrap substantially impermeable to the liquid payload of the capsule 11. Alternatively or in addition, the second plug wrap 9 and/or tipping paper 5 can comprise a barrier coating to make the material of that plug wrap and/or tipping paper substantially impermeable to the liquid payload of the capsule 11.

In the present example, the capsule 11 is spherical and has a diameter of about 3 mm. In other examples, other shapes and sizes of capsule can be used. The total weight of the capsule 11 may be in the range about 10 mg to about 50 mg.

In the present example, the capsule 11 is located at a longitudinally central position within the body of material 6. That is, the capsule 11 is positioned so that its centre is 4 mm from each end of the body of material 6. In other examples, the capsule 11 can be located at a position other than a longitudinally central position in the body of material 6, i.e. closer to the downstream end of the body of material 6 than the upstream end, or closer to the upstream end of the body of material 6 than the downstream end.

Preferably, the mouthpiece 2′ is configured so that the capsule 11 and the ventilation holes 12 are longitudinally offset from each other in the mouthpiece 2′.

A cross section of the mouthpiece 2′ is shown in FIG. 2b, this being taken through line A-A′ of FIG. 2a. FIG. 2b shows the capsule 11, the body of material 6, the first and second plug wraps 7′, 9 and the tipping paper 5. In the present example, the capsule 11 is centred on the longitudinal axis (not shown) of the mouthpiece 2′. The first and second plug wraps 7′, 9 and tipping 5 are arranged concentrically around the body of material 6.

The breakable capsule 11 has a core-shell structure. That is, the encapsulating material or barrier material creates a shell around a core that comprises the aerosol modifying agent. The shell structure hinders migration of the aerosol modifying agent during storage of the article 1′ but allows controlled release of the aerosol modifying agent, also referred to as an aerosol modifier, during use.

In some cases, the barrier material (also referred to herein as the encapsulating material) is frangible. The capsule is crushed or otherwise fractured or broken by the user to release the encapsulated aerosol modifier. Typically, the capsule is broken immediately prior to heating being initiated but the user can select when to release the aerosol modifier. The term “breakable capsule” refers to a capsule, wherein the shell can be broken by means of a pressure to release the core; more specifically the shell can be ruptured under the pressure imposed by the user's fingers when the user wants to release the core of the capsule.

In some cases, the barrier material is heat resistant. That is to say, in some cases, the barrier will not rupture, melt or otherwise fail at the temperature reached at the capsule site during operation of the aerosol provision device. Illustratively, a capsule located in a mouthpiece may be exposed to temperatures in the range of 30° C. to 100° C. for example, and the barrier material may continue to retain the liquid core up to at least about 50° C. to 120° C.

In other cases, the capsule releases the core composition on heating, for example by melting of the barrier material or by capsule swelling leading to rupture of the barrier material.

The total weight of a capsule may be in the range of about 1 mg to about 100 mg, suitably about 5 mg to about 60 mg, about 8 mg to about 50 mg, about 10 mg to about 20 mg, or about 12 mg to about 18 mg.

The total weight of the core formulation may be in the range of about 2 mg to about 90 mg, suitably about 3 mg to about 70 mg, about 5 mg to about 25 mg, about 8 mg to about 20 mg, or about 10 mg to about 15 mg.

The capsule according to the invention comprises a core as described above, and a shell. The capsules may present a crush strength from about 4.5 N to about 40 N, more preferably from about 5 N to about 30 N or to about 28 N (for instance about 9.8 N to about 24.5 N). The capsule burst strength can be measured when the capsule is removed from the body of material 6 and using a force gauge to measure the force at which the capsule bursts when pressed between two flat metal plates. A suitable measurement device is the Sauter FK 50 force gauge with a flat headed attachment, which can be used to crush the capsule against a flat, hard surface having a surface similar to the attachment.

The capsules may be substantially spherical and have a diameter of at least about 0.4 mm, 0.6 mm, 0.8 mm, 1.0 mm, 2.0 mm, 2.5 mm, 2.8 mm or 3.0 mm. The diameter of the capsules may be less than about 10.0 mm, 8.0 mm, 7.0 mm, 6.0 mm, 5.5 mm, 5.0 mm, 4.5 mm, 4.0 mm, 3.5 mm or 3.2 mm. Illustratively, the capsule diameter may be in the range of about 0.4 mm to about 10.0 mm, about 0.8 mm to about 6.0 mm, about 2.5 mm to about 5.5 mm or about 2.8 mm to about 3.2 mm. In some cases, the capsule may have a diameter of about 3.0 mm. These sizes are particularly suitable for incorporation of the capsule into an article as described herein.

The cross-sectional area of the capsule 11 at its largest cross sectional area is in some embodiments less than 28% of the cross sectional area of the portion of the mouthpiece 2′ in which the capsule 11 is provided, more preferably less than 27% and still more preferably less than 25%. For instance, for the spherical capsule having a diameter of 3.0 mm, the largest cross sectional area of the capsule is 7.07 mm². For the mouthpiece 2′ having a circumference of 21 mm as described herein, the body of material 6 has an outer circumference of 20.8 mm, and the radius of this component will be 3.31 mm, corresponding to a cross sectional area of 34.43 mm². The capsule cross sectional area is, in this example, 20.5% of the cross-sectional area of the mouthpiece 2′. As another example, if the capsule had a diameter of 3.2 mm, its largest cross sectional area would be 8.04 mm². In this case, the cross sectional area of the capsule would be 23.4% of the cross sectional area of the body of material 6. A capsule with a largest cross sectional area less than 28% of the cross sectional area of the portion of the mouthpiece 2′ in which the capsule 11 is provided has the advantage that the pressure drop across the mouthpiece 2′ is reduced as compared to capsules with larger cross sectional areas and adequate space remains around the capsule for aerosol to pass without the body of material 6 removing significant amounts of the aerosol mass as it passes through the mouthpiece 2′.

Preferably the pressure drop or difference (also referred to a resistance to draw) across the article, measured as the open pressure drop (i.e. with the ventilation openings open), reduces by less than 8 mmH₂ O when the capsule is broken. More preferably, the open pressure drop reduces by less than 6 mmH₂O and more preferably less than 5 mmH₂O. These values are measured as the average achieved by at least 80 articles made to the same design. Such small changes in pressure drop mean that other aspects of the product design, such as setting the correct ventilation level for a given product pressure drop, can be achieved irrespective of whether or not the consumer chooses to break the capsule.

The barrier material may comprise one or more of a gelling agent, a bulking agent, a buffer, a colouring agent and a plasticiser.

Suitably, the gelling agent of the capsule may be, for example, a polysaccharide or cellulosic gelling agent, a gelatin, a gum, a gel, a wax or a mixture thereof. Suitable polysaccharides include alginates, dextrans, maltodextrins, cyclodextrins and pectins. Suitable alginates include, for instance, a salt of alginic acid, an esterified alginate or glyceryl alginate. Salts of alginic acid include ammonium alginate, triethanolamine alginate, and group I or II metal ion alginates like sodium, potassium, calcium and magnesium alginate. Esterified alginates include propylene glycol alginate and glyceryl alginate. In an embodiment, the barrier material is sodium alginate and/or calcium alginate. Suitable cellulosic materials include methyl cellulose, ethyl cellulose, hydroxyethyl cellulose, hydroxypropyl cellulose, carboxymethyl cellulose, cellulose acetate and cellulose ethers. The gelling agent may comprise one or more modified starches. The gelling agent may comprise carrageenans. Suitable gums include agar, gellan gum, gum Arabic, pullulan gum, mannan gum, gum ghatti, gum tragacanth, Karaya, locust bean, acacia gum, guar, quince seed and xanthan gums. Suitable gels include agar, agarose, carrageenans, furoidan and furcellaran. Suitable waxes include carnauba wax. In some cases, the gelling agent may comprise carrageenans and/or gellan gum; these gelling agents are particularly suitable for inclusion as the gelling agent as the pressure required to break the resulting capsules is particularly suitable.

The barrier material may comprise one or more bulking agents, such as starches, modified starches (such as oxidised starches) and sugar alcohols such as maltitol.

The barrier material may comprise a colouring agent which renders easier the location of the capsule within the aerosol generating device during the manufacturing process of the aerosol generating device. The colouring agent is preferably chosen among colorants and pigments.

The barrier material may further comprise at least one buffer, such as a citrate or phosphate compound.

The barrier material may further comprise at least one plasticiser, which may be glycerol, sorbitol, maltitol, triacetin, polyethylene glycol, propylene glycol or another polyalcohol with plasticising properties, and optionally one acid of the monoacid, diacid or triacid type, especially citric acid, fumaric acid, malic acid, and the like. The amount of plasticiser ranges from 1% to 30% by weight, preferably from 2% to 15% by weight, and even more preferably from 3 to 10% by weight of the total dry weight of the shell.

The barrier material may also comprise one or more filler materials. Suitable filler materials include comprising starch derivatives such as dextrin, maltodextrin, cyclodextrin (alpha, beta or gamma), or cellulose derivatives such as hydroxypropyl-methylcellulose (HPMC), hydroxypropylcellulose (HPC), methylcellulose (MC), carboxy-methylcellulose (CMC), polyvinyl alcohol, polyols or mixture thereof. Dextrin is a preferred filler. The amount of filler in the shell is at most 98.5%, preferably from 25 to 95% more preferably from 40 to 80% and even more preferably from 50 to 60 % by weight on the total dry weight of the shell.

The capsule shell may additionally comprise a hydrophobic outer layer which reduces the susceptibility of the capsule to moisture-induced degradation. The hydrophobic outer layer is suitably selected from the group comprising waxes, especially carnauba wax, candelilla wax or beeswax, carbowax, shellac (in alcoholic or aqueous solution), ethyl cellulose, hydroxypropyl methyl cellulose, hydroxyl-propylcellulose, latex composition, polyvinyl alcohol, or a combination thereof. More preferably, the at least one moisture barrier agent is ethyl cellulose or a mixture of ethyl cellulose and shellac.

The capsule core comprises the aerosol modifier. This aerosol modifier may be any volatile substance which modifies at least one property of the aerosol. For example, the aerosol substance may modify the pH, the sensorial properties, the water content, the delivery characteristics or the flavour. In some cases, the aerosol modifier may be selected from an acid, a base, water or a flavourant. In some embodiments, the aerosol modifier comprises one or more flavourants.

The flavourant may suitably be licorice, rose oil, vanilla, lemon oil, orange oil, a mint-flavour, suitably menthol and/or a mint oil from any species of the genus Mentha such as peppermint oil and/or spearmint oil, or lavender, fennel or anise.

In some cases, the flavourant comprises menthol.

In some cases, the capsule may comprise at least about 25% w/w flavourant (based on the total weight of the capsule), suitably at least about 30% w/w flavourant, 35% w/w flavourant, 40% w/w flavourant, 45% w/w flavourant or 50% w/w flavourant.

In some cases, the core may comprise at least about 25% w/w flavourant (based on the total weight of the core), suitably at least about 30% w/w flavourant, 35% w/w flavourant, 40% w/w flavourant, 45% w/w flavourant or 50% w/w flavourant. In some cases, the core may comprise less than or equal to about 75% w/w flavourant (based on the total weight of the core), suitably less than or equal to about 65% w/w flavourant, 55% w/w flavourant, or 50% w/w flavourant. Illustratively, the capsule may include an amount of flavourant in the range of 25-75% w/w (based on the total weight of the core), about 35-60% w/w or about 40-55% w/w.

The capsules may include at least about 2 mg, 3 mg or 4 mg of the aerosol modifier, suitably at least about 4.5 mg of the aerosol modifier, 5 mg of the aerosol modifier, 5.5 mg of the aerosol modifier or 6 mg of the aerosol modifier.

In some cases, the consumable comprises at least about 7 mg of the aerosol modifier, suitably at least about 8 mg of the aerosol modifier, 10 mg of the aerosol modifier, 12 mg of the aerosol modifier or 15 mg of the aerosol modifier. The core may also comprise a solvent which dissolves the aerosol modifier.

Any suitable solvent may be used.

Where the aerosol modifier comprises a flavourant, the solvent may suitably comprise short or medium chain fats and oils. For example, the solvent may comprise tri-esters of glycerol such as C2-C12 triglycerides, suitably C6-C10 triglycerides or Cs-C12 triglycerides. For example, the solvent may comprise medium chain triglycerides (MCT-C8-C12), which may be derived from palm oil and/or coconut oil.

The esters may be formed with caprylic acid and/or capric acid. For example, the solvent may comprise medium chain triglycerides which are caprylic triglycerides and/or capric tryglycerides. For example, the solvent may comprise compounds identified in the CAS registry by numbers 73398-61-5, 65381-09-1, 85409-09-2. Such medium chain triglycerides are odourless and tasteless.

The hydrophilic-lipophilic balance (HLB) of the solvent may be in the range of 9 to 13, suitably 10 to 12. Methods of making the capsules include co-extrusion, optionally followed by centrifugation and curing and/or drying. The contents of WO 2007/010407 A2 is incorporated by reference, in its entirety.

In the examples described above, the mouthpieces 2, 2′ each comprise a single body of material 6. In other examples, either the mouthpiece of FIG. 1 or of FIGS. 2a and 2b may include multiple bodies of material. The mouthpieces 2, 2′ may comprise a cavity between the bodies of material.

In some examples, the mouthpiece 2, 2′ downstream of the aerosol generating material 3 can comprise a wrapper, for instance the first or second plug wraps 7, 9, or tipping paper 5, which comprises an aerosol modifying agent as described herein or other sensate material. The aerosol modifying agent may be disposed on an inwardly or outwardly facing surface of the mouthpiece wrapper. For instance, the aerosol modifying agent or other sensate material may be provided on an area of the wrapper, such as an outwardly facing surface of the tipping paper 5, which comes into contact with the consumer's lips during use. By disposing the aerosol modifying agent or other sensate material on the outwardly facing surface of the mouthpiece wrapper, the aerosol modifying agent or other sensate material may be transferred to the consumer's lips during use. Transfer of the aerosol modifying agent or other sensate material to the consumer's lips during use of the article may modify the organoleptic properties (e.g. taste) of the aerosol generated by the aerosol generating substrate 3 or otherwise provide the consumer with an alternative sensory experience. For example, the aerosol modifying agent or other sensate material may impart flavour to the aerosol generated by the aerosol generating substrate 3. The aerosol modifying agent or other sensate material may be at least partially soluble in water such that it is transferred to the user via the consumer's saliva. The aerosol modifying agent or other sensate material may be one that volatilises by the heat generated by the aerosol provision system. This may facilitate transfer of the aerosol modifying agent to the aerosol generated by the aerosol generating substrate 3. A suitable sensate material may be a flavour as described herein, sucralose or a cooling agent such as menthol or similar.

According to embodiments described herein, a pack can be provided comprising a plurality of articles as described herein. The number of the plurality of strips of aerosol generating non-tobacco material in each article can vary by less than 40% between the articles in the pack, or less than 30% between the articles in the pack, or less than 20% between the articles in the pack. Alternatively or in addition, the plurality of strips of aerosol generating non-tobacco material in each article in a pack can comprise a flavourant, and the delivery of the flavourant from each of the plurality of articles, in use, varies by less than 50% between the articles in the pack, or varies by less than 20% between the articles in the pack. For example, the standard deviation in the inclusion level of the flavourant by percentage weight between articles in the pack may be less than 50%, or less than 30%, or less than 20%, for instance between 5% and 50%, or between 5% and 30%, or between 10% and 25% of the mean. The flavourant level may be determined by chemical analysis as known to those skilled in the art, and the standard deviation may be determined for a batch of at least 10 articles, for instance a pack of articles.

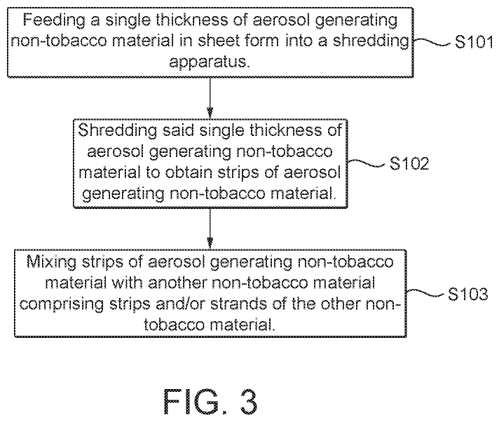

FIG. 3 illustrates a first method of manufacturing an aerosol-generating material, for instance and aerosol-generating material for use in an article for use in a non-combustible aerosol provision system.

At step S101 a single thickness of aerosol generating non-tobacco material in sheet form is fed into a shredding apparatus. This can be achieved, for example, by providing a bobbin of aerosol generating non-tobacco sheet material which can be continuously fed into a shredding apparatus. Alternatively, a discrete portion of aerosol generating non-tobacco material in sheet form, such as a sheet known to those skilled in the art as a flag, can be fed into a shredding apparatus. The inventors have surprisingly found that, in contrast to the conventional tobacco cutting process where several sheets of lamina material are fed to a cutting apparatus simultaneously, there are benefits for aerosol generating non-tobacco material in sheet form when shredded in single sheet thicknesses. Feeding multiple thicknesses of aerosol generating non-tobacco sheet material into a shredding apparatus in a single pass tends to result in uneven distribution of the material in the final aerosol-generating material, as multiple thicknesses of the sheet material potentially adhere together, resulting in the formation of clumps. Alternatively, multiple thicknesses of aerosol generating non-tobacco sheet material can be fed into a shredding apparatus in a single pass, for instance where the ‘tackiness’ of the aerosol generating non-tobacco sheet is relatively low, avoiding the formation of clumps.

At step S102, said single thickness of aerosol generating non-tobacco material is shredded to obtain strips of aerosol generating non-tobacco material having a defined cut width. Optionally the aerosol generating non-tobacco material may be subject to a second cutting step, such as in a cross-cut type shredding process, to obtain a defined cut length.

At step S103, the strips of aerosol generating non-tobacco material obtained in step S102 are mixed with another non-tobacco material. The inventors have advantageously found that mixing of the shredded aerosol generating non-tobacco material with another non-tobacco material should preferably be carried out as soon after step S102 as possible. The inventors have found that prolonged storage of shredded aerosol generating non-tobacco material can result in clumps of aerosol generating non-tobacco shreds forming in the shredded material, such that when the shredded aerosol generating non-tobacco material is mixed with the other non-tobacco material, and used to form articles as described herein, the clumps of aerosol generating non-tobacco material result in an uneven distribution of aerosol generating non-tobacco material between articles, and within individual rods of aerosol-generating material.

In some embodiments, the shredded aerosol generating non-tobacco material is incorporated into the other non-tobacco material fewer than 12 hours after the cutting step, for instance fewer than 6 hours, or fewer than 4 hours, or fewer than 2 hours, or fewer than 1 hour. Optionally, the shredded aerosol generating non-tobacco material may be fed into the other non-tobacco material in an online process, such that the time between shredding of the aerosol generating non-tobacco material and incorporation of the shredded material into the other non-tobacco material to form the final aerosol-generating material may be less than 30 seconds, for instance less than 20 seconds, or less than 10 seconds.

In some embodiments, a method of producing an aerosol-generating material comprises cutting a sheet of aerosol generating non-tobacco material to form a plurality of strips of aerosol generating non-tobacco material having a cut length of at least about 5 mm, or at least about 10 mm, or at least about 20 mm. In some embodiments, the method comprises cutting a sheet of aerosol generating non-tobacco material to form a plurality of strips of aerosol generating non-tobacco material each having a cut length of between about 5 mm and about 60 mm, or between about 10 mm and about 55 mm, or between about 20 mm and about 50 mm.

The mixing step can be performed using a rotary drum blender, for instance rotating at an RPM of 5 to 30 RPM, for instance 10-15 RPM. The drum diameter can be between 0.8 m and 1.2 m with 5 sets of 10 to 20 pins (optional) projecting from the inner walls of the drum towards the centre of the drum, the pins having a length of between 5% and 15% of the drum diameter, for instance about 10%, with the pins of each set spaced longitudinally along the length of the drum and each set spaced around the inner circumference. The drum angle of its central axis during the mixing operation can be approximately 10 to 30 degrees from horizontal (open side up). Batches of 5-20 kg total solids, typically 8-10 kg, can be mixed in such a drum, with a mixing time of 30 seconds to 10 minutes, for instance 30 seconds to 2 minutes.

Alternatively, the mixing step can be incorporated into the standard primary manufacturing process for tobacco material, for instance using the add-back line and a flavour mixing cylinder. This method may be suited to larger quantities of material. A continuous rotary drum blender can be used, which is fed by two weigh conveyors, each feeding one component (the other non-tobacco material, such as paper or cut aerosol generating non-tobacco material, such as shredded gel) at the correct relative kg/hr rate to achieve the desired inclusion level of aerosol generating non-tobacco in the aerosol-generating material. The components are blended in the rotating drum blender during their passage, and collected at the exit. Typical dimensions and operating conditions of a continuous rotary drum blender are an RPM of 12-15 RPM, a drum diameter of 0.6-0.8 m, a drum length of 2.0-3.0 m. The residence time of the materials in the drum can be between 30-120 seconds (typically 40-70 seconds).

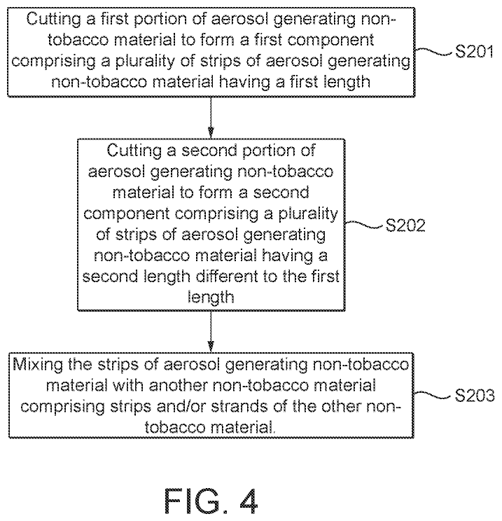

FIG. 4 illustrates a second method of manufacturing an aerosol-generating material, for instance and aerosol-generating material for use in an article for use in a non-combustible aerosol provision system. The second method can be performed using equipment as described in relation to the first method above, and the skilled person would be aware that the steps of the first and second methods can be combined as appropriate. The method includes a step (S201) of cutting a first portion of aerosol generating non-tobacco material to form a first component comprising a plurality of strips of aerosol generating non-tobacco material having a first length. The method also includes a step (S202) of cutting a second portion of aerosol generating non-tobacco material to form a second component comprising a plurality of strips of aerosol generating non-tobacco material having a second length different to the first length. At step S203, the cut strips of aerosol generating non-tobacco material are mixed with another non-tobacco material comprising strips and/or strands of the other non-tobacco material. Using two or more different lengths of aerosol generating non-tobacco material can enable the size of the strips of the aerosol generating non-tobacco material to more closely match the material size distribution of the other non-tobacco material, resulting in better mixing of the aerosol generating non-tobacco and the other non-tobacco material.

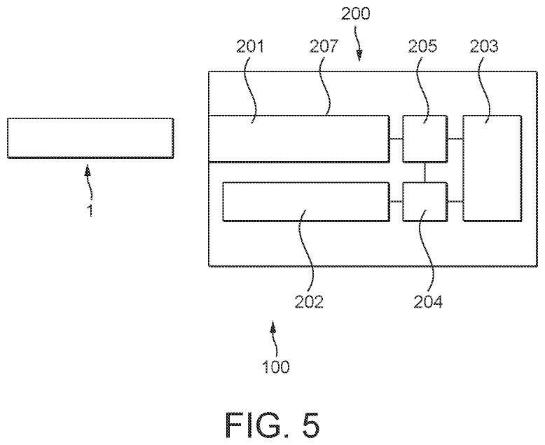

FIG. 5 illustrates a non-combustible aerosol provision system 100 comprising an article 1 and a non-combustible aerosol provision device 200. The device comprises an area 201 for receiving the article 1 and an aerosol generator 202. The article 1 may be any of the example articles 1 described herein.

The aerosol generator 202 is configured to heat the aerosol generating material 3 of the article 1 when the article 1 is received in the area 201 for receiving the consumable. The device further comprises a power source 203, a controller 204 and a puff sensor 205. In use, a user inserts the article 1 into the area 201 for receiving the consumable and activates the aerosol generator 202 to generate an aerosol for inhalation. The user may then draw on the mouthpiece 2 of the article 1 or, alternatively, on a mouthpiece of the device 200 (not shown) to inhale the aerosol. In the illustrated example, the article 1 and device 200 are configured so that the mouthpiece 2 is a part of the article 1 that protrudes from the area 201 when the article 1 is fully inserted into the device 200. Therefore, the mouthpiece 2 is available for a user to draw on the mouthpiece 2 while the user holds the device 200.

The puff sensor 205 is configured to detect when a user is drawing on the mouthpiece 2 of the article 1 within the device 200 and to send a signal to the controller 204 to activate the aerosol generator 202. Therefore, aerosol is generated concurrently with the user inhaling on the article 1. Alternatively, the device 200 may be provided with a user interface—such as a button (not shown)—that the user may press to cause activation of the aerosol generator 202.

The area 201 for receiving the article 1 is provided with an inlet (not shown) to allow air into area 201 before passing through the article 1 when a user draws on the mouthpiece 2 of the article 1. Therefore, a flow of air is directed through the article 1 when a user draws on the article 1. The flow of air entrains the aerosol generated by the aerosol generating material 3 of the article 1 for inhalation by the user.

The aerosol generator 202 comprises any suitable means for heating the aerosol generating material 3 of an article 1 received in said area 201 of the device 200. Power for the aerosol generator 202 is provided by the power source 203, which in the illustrated example is an electrical power source 203, such as a battery 203.

In one example, the aerosol generator 202 comprises a magnetic field generator configured to generate a varying magnetic field that penetrates the area 201 for receiving the article 1. Therefore, the device 200 is configured for use with the articles 1 comprising a susceptor (not shown). The varying magnetic field heats the susceptor by magnetic hysteresis. When the article 1 is placed within the device 200 and the aerosol generator 202 is activated, a varying magnetic field penetrates the susceptor of the article 1 and causes heating of aerosol generating material 3 in thermal contact with the susceptor, generating an aerosol for inhalation by a user.

In another example, the aerosol generator 202 comprises a susceptor in thermal contact with the area 201 for receiving the article 1; and a magnetic field generator for generating a varying magnetic field that penetrates the susceptor. The varying magnetic field heats the susceptor by magnetic hysteresis. The susceptor in turn heats the area 201 for receiving the consumable. Therefore, when an article 1 is placed within the device 200 and the aerosol generator 202 is activated, a varying magnetic field penetrates the susceptor and causes heating of area 201 in which the article 1 is received. The heat is transferred to the aerosol generating material 3 of the article 1, generating an aerosol for inhalation by the user. In such examples, the wall 207 of the area 201 for receiving the article 1 may comprise the susceptor. The article 1 may be configured for direct contact with the wall 207 for efficient heat transfer. Alternatively, or additionally, the area 201 may comprise a susceptor as a projection configured to penetrate the aerosol generating material 3 when the article 1 is inserted into the area 201. The projection may take the form of a blade or pin terminating in a point. That is, the projection has a length dimension that is greater than its width dimension or diameter.

In another example, the aerosol generator 202 comprises a material heatable by electrical conduction, the material being provided in thermal contact with the area 201 for receiving the article 1. Therefore, when an article 1 is placed within the device 200 and the aerosol generator 202 is activated, a current is passed through the material to heat area 201 in which the article 1 is received. The heat is transferred to the aerosol generating material 3 of the article 1, generating an aerosol for inhalation by the user. In such embodiments, the material may be the wall 207 of the area 201 for receiving the article 1 and the article 1 may be configured for direct contact with the wall 207 for efficient heat transfer. Alternatively, or additionally, the area 201 may comprise a projection heatable by electrical conduction configured to penetrate the aerosol generating material 3 when the article 1 is inserted into the area 201. The projection may take the form of a blade or pin terminating in a point. That is, the projection has a length dimension that is greater than its width dimension or diameter.

In any of the above examples of aerosol generator 202, the aerosol generator 202 may be configured for zonal or sectional heating of the article 1. By ‘zonal or sectional heating’ it is meant that the aerosol generator 202 is configured to heat discreet portions of the aerosol generating material 3 separately, that is to say, at different points in time.

In any of the embodiments described herein either the aerosol generating non-tobacco material and/or the other non-tobacco material may be a non-tobacco botanical material. The non-tobacco botanical material may be or comprise including rooibos.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol-generating material comprising a plurality of strands and/or strips of an aerosol generating non-tobacco material and a plurality of strips of an other non-tobacco material.

2. The aerosol-generating material according to claim 1, wherein the plurality of strips of aerosol generating non-tobacco material have an area density between about 55 and about 135 grams per square metre, or between about 80 and about 100 grams per square metre, or between about 100 and 125 grams per square metre.

3. The aerosol-generating material according to claim 1, wherein the other non-tobacco material comprises aerosol-former in an amount less than 10 wt % of the tobacco material.

4. The aerosol-generating material according to claim 1, wherein an area density of the plurality of strips of aerosol generating non-tobacco material is between 70% and 110% of the area density of the other non-tobacco material.

5. The aerosol-generating material according to claim 1, wherein the other non-tobacco material comprises a reconstituted fibrous material.

6. The aerosol-generating material according to claim 1, wherein the other non-tobacco material comprises a paper and/or comprises a non-tobacco organic material and, optionally, wherein the non-tobacco organic material comprises rooibos.

7. The aerosol-generating material according to claim 5, wherein the other non-tobacco material has an area density between 80 grams per square metre and 120 grams per square metre.

8. The aerosol-generating material according to claim 1, wherein the plurality of strips of aerosol generating non-tobacco material have a non-uniform distribution of lengths.

9. The aerosol-generating material according to claim 8, wherein the non-uniform distribution of lengths of the plurality of strips of aerosol generating non-tobacco material is a multi-modal distribution.

10. The aerosol-generating material according to claim 8, wherein the plurality of strips of the other non-tobacco material have a multi-modal distribution of lengths.

11. The aerosol-generating material according to claim 1, wherein a distribution of lengths of the plurality of strips of other non-tobacco material and the distribution of lengths of the plurality of strips of the aerosol generating non-tobacco material have the same number of modes.

12. The aerosol-generating material according to claim 10, wherein a number of modes of the multi-modal distribution of the lengths of the plurality of strips of aerosol generating non-tobacco material is selected to match the number of modes of the distribution of lengths of the strands and/or strips of aerosol generating non-tobacco material.

13. The aerosol-generating material according to claim 1, wherein at least one of the plurality of strips of aerosol generating non-tobacco material has a length greater than about 5, or greater than about 10 mm.

14. The aerosol-generating material according to claim 1, wherein between 50% and 90% of the plurality of strips of aerosol generating non-tobacco material have a length of between 35mm and 45mm.

15. The aerosol-generating material according to claim 14, wherein between 60% and 85% of the plurality of strips of aerosol generating non-tobacco material have a length of between 35mm and 45mm.

16. The aerosol-generating material according to claim 14, wherein at least 50% of the remaining plurality of strips of the aerosol generating non-tobacco material have a length of between 10mm and 30mm.

17. The aerosol-generating material according to claim 1, wherein at least one of the plurality of strips of the aerosol generating non-tobacco material has a length between about 10 mm and about 60 mm, or between about 20 mm and about 50 mm.

18. The aerosol-generating material according to claim 1, wherein each of the plurality of strips of the aerosol generating non-tobacco material has a length between about 10 mm and about 60 mm, or between about 20 mm and about 50 mm.

19. The aerosol-generating material according to claim 1, wherein the strips of aerosol generating non-tobacco material have an average cut width of between 0.75 mm and 2 mm.

20. The aerosol-generating material according to claim 1, wherein the strips of aerosol generating non-tobacco material have an average cut width of between 0.8 mm and 1.75 mm.

21. The aerosol-generating material according to claim 1, wherein the strips of aerosol generating non-tobacco material have an average cut width of between 1 mm and 1.5 mm.

22. The aerosol-generating material according to claim 1, wherein the aerosol-generating material comprises an aerosol-former, optionally glycerol, and/or optionally in an amount between 10 wt % and 20 wt % of the aerosol-generating material including said aerosol generating non-tobacco material.

23. The aerosol-generating material according to claim 1, wherein the other non-tobacco material comprises water in an amount between 5 wt % and 10 wt %, or between 7.5 wt % and 9.5 wt %.

24. The aerosol-generating material according to claim 1, wherein the non-tobacco aerosol generating material comprises an aerosol generating film comprising:
a binder;
optionally a filler; and
optionally an active and/or a flavourant.

25. The aerosol-generating material according to claim 24, wherein aerosol generating film is up to about 1 mm thick and, optionally, up to 500 microns thick and, optionally, 50 to 500 microns thick.

26. The aerosol-generating material according to claim 1, wherein the other non-tobacco material comprises:
nicotine in an amount of 5% by weight of the other non-tobacco material;
a binder in an amount of 10% by weight of the other non-tobacco material;
glycerol in an amount of 20% by weight of the other non-tobacco material; and
a filler material.

27. An article comprising an aerosol-generating material according to claim 1.

28. The article according to claim 27, wherein the aerosol-generating material comprises aerosol-former, optionally glycerol, in an amount from 10 wt % to 15 wt %, or from 12 wt % to 14 wt %.

29. A consumable for use in an aerosol provision system, wherein the consumable comprises the article according to claim 27.

30. The consumable according to claim 29, wherein the aerosol-generating material is provided in the form of a rod having a first end and a second end, and wherein a portion of the rod between the first end of the rod and a longitudinal position half-way between the first and second ends comprises from 20% to 80% of the aerosol generating non-tobacco material in the rod.

31. A non-combustible aerosol provision system comprising a non-combustible aerosol provision device and the consumable according to claim 29, wherein the non-combustible aerosol provision device is arranged to heat the aerosol-generating material of the consumable.

32. A method for producing an aerosol-generating material according to claim 1, comprising cutting a sheet of aerosol generating non-tobacco material to form a plurality of strips of aerosol generating non-tobacco material.

33. A method for producing an aerosol-generating material, comprising feeding a single thickness sheet of an aerosol generating non-tobacco material into a cutting apparatus to form a plurality of strips of aerosol generating non-tobacco material.

34. The method according to claim 32, comprising cutting the plurality of strips of aerosol generating non-tobacco material across a width of the strips, optionally wherein the strips of aerosol generating non-tobacco material are cut width-wise and lengthwise in one step.

35. A method for producing an aerosol-generating material, the method comprising:
cutting a first portion of aerosol generating non-tobacco material to form a first component comprising a plurality of strips of aerosol generating non-tobacco material having a first length; and
cutting a second portion of aerosol generating non-tobacco material to form a second component comprising a plurality of strips of aerosol generating non-tobacco material having a second length different to the first length.

36. The method according to claim 35, wherein the first component and the second component are mixed to form a plurality of strips of aerosol generating non-tobacco material having a non-uniform distribution of lengths.

37. The method according to claim 32, further comprising a mixing step, wherein the plurality of strips of aerosol generating non-tobacco material are mixed with a tobacco material.

38. A method for producing an aerosol-generating material, comprising:
cutting a sheet of aerosol generating non-tobacco material to form a plurality of strips of the aerosol generating non-tobacco material, and
mixing the plurality of strips of aerosol generating non-tobacco material with a tobacco material,
wherein the cutting step and the mixing step are performed within 12 hours of each other, or within 6 hours of each other, or within 2 hours of each other, or within 30 seconds of each other.

39. The method according to claim 38, wherein the plurality of strips of aerosol generating non-tobacco material are transported between the cutting step and the mixing step.

40. The method according to claim 32, wherein the aerosol generating non-tobacco material is cut to form strips in a shredder, optionally wherein the shredder is a cross-cut type shredder.

41. The method according to claim 40, wherein the shredder is configured to produce a plurality of strips of material having a range of lengths.
